(19) United States
(12) Patent Application Publication
(10) Pub. No.: US 2025/0124296 A1
(43) Pub. Date: Apr. 17, 2025

(54) ELASTIC TRANSFORMER SERVING SYSTEM VIA TOKEN ADAPTATION

(71) Applicant: The Hong Kong University of Science and Technology, Kowloon (HK)

(72) Inventor: Song Guo, New Territories (HK)

(21) Appl. No.: 18/907,660

(22) Filed: Oct. 7, 2024

Related U.S. Application Data
(60) Provisional application No. 63/591,112, filed on Oct. 17, 2023.

(51) Int. Cl. G06N 3/091; G06N 3/045

(52) U.S. Cl. CPC G06N 3/091; G06N 3/045

(57) ABSTRACT

An elastic transformer serving system, referred to herein as an online token adaptation system (OTAS), is described that accommodates diverse user requests with fluctuating query louds while optimizing output accuracy and runtime latency. The OTAS uses a token adaptation technique that involves adding prompting tokens to improve accuracy and removing redundant tokens to accelerate inference. To cope with fluctuating query loads and diverse user requests, the OTAS further uses application-aware selective batching in combination with online token adaptation. In an example embodiment, the OTAS first batches incoming queries with similar service-level objects to improve the ingress throughput. Then, to strike a trade-off between the overhead of token increment and the potential for accuracy improvement, the OTAS adaptively adjusts the token execution settings by solving an optimization problem.

### CROSS REFERENCE TO RELATED APPLICATION

This is a nonprovisional patent application claiming priority, under 35 U.S.C. § 119, to U.S. Provisional Patent Application No. 63/591,112, filed on Oct. 17, 2023, and entitled “Elastic Transformer Serving System via Token Adaptation”, the entirety of which prior application is hereby incorporated by reference herein.

### TECHNICAL FIELD

This application relates to cloud-based transformer model serving for artificial intelligence (AI) applications, and, more particularly, to an elastic transformer serving system via token adaptation.

### BACKGROUND

It is important to be able to effectively and efficiently serve machine learning models for artificial intelligence (AI) applications via cloud-based architectures for many industries, which can substantially affect the quality of the user experience and the accompanied economic profits. For example, Facebook™ has billions of daily active users and issues tens of trillions of model inference queries per day, which necessitates fundamental re-designs for facilitating model optimization and serving efficiency.

Recent advances in self-supervised pre-training techniques have boosted the development of large transformer models for many AI applications. These pre-trained transformer models have dramatically revolutionized our lives and brought remarkable potential to our society. For example, large generative pre-trained transformer (“GPT”) models like GPT-2 and GPT-3 have spawned a host of AI applications, such as Copilot™ and ChatGPT™, and others. In particular, ChatGPT™ had more than 100 million active users and received 176 million visits in April 2023.

Despite the explosion of such diverse applications, the resource-intensive nature of transformer models, coupled with dynamic query loads and heterogeneous user requirements, have exacerbated the challenges associated with cloud-based transformer model serving, making it extremely challenging to accommodate various service demands efficiently. For example, existing techniques used to improve service quality in association with accounting for different user requirements and service demands involve model adaptation. Model adaptation involves training multiple model variants of a foundation transformer model with different sizes to accommodate varying service demands. These multiple model variants are stored by the serving system and dynamically selected and applied to accommodate the variations in query load. Unfortunately, this technique is not suitable for large transformer models because training these models can be prohibitive in terms of high monetary costs and time overhead. For example, training the GPT-3 model can consume several thousand petaflops and days of computing power and cost millions of dollars. In addition, loading such kind of model to the serving system processing unit (e.g., a graphics processing unit (GPU) or the like) for execution may take several seconds, which can add up to huge latency costs as used to serve a large number of user queries (hundreds, thousands, millions, etc.) even over a relatively short serving period (e.g., thirty minutes or so). Moreover, the size of different transformer models varies significantly, and it is hard to prepare different fine-grained model versions tailored to different inferencing tasks.

Thus, techniques for efficiently facilitating provision of cloud-based transformer models with reduced training costs and computational resources that accommodate dynamic query loads and heterogenous user requirements are needed.

### SUMMARY

The following presents a summary to provide a basic understanding of one or more embodiments of the present application. This summary is not intended to identify key or critical elements or delineate any scope of the different embodiments or any scope of the claims. Its sole purpose is to present concepts in a simplified form as a prelude to the more detailed description that is presented later. In one or more embodiments, systems, computer-implemented methods, apparatus and/or computer program products are described that facilitate an elastic transformer serving system via token adaptation.

According to an embodiment, a computing system, comprising at least one processor is provided that is configured to receive queries for processing by a transformer model in association with processing tokenized representations of respective input data samples of the queries, the tokenized representations comprising respective initial token numbers of execution tokens. The computing system is further configured to determine token execution settings for the processing of the queries using the transformer model based on one or more characteristics of the queries, wherein at least some of the token execution settings comprise a token adaptation setting that comprises adjusting at least some the respective initial token numbers using the transformer model via at least one of a token prompting process or a token merging process. After directing the transformer model to employ the token execution settings, the computing system applies the queries as input to the transformer model to generate inference results for the queries.

To this end, the adjusting of the (at least some of the) respective initial token numbers using the transformer model via the token prompting process results in increasing an accuracy level of the inference results. In addition, the adjusting of the (at least some of the) respective initial token numbers using the transformer model via the token merging process results in decreasing a latency level of the transformer model in association with the processing of the queries.

In one or more embodiments, the one or more characteristics are selected from the group consisting of: a first characteristic applicable to input data sample content, a second characteristic applicable to a query task, a third characteristic applicable to a utility value and a fourth characteristic applicable to a latency requirement. In accordance with the disclosed techniques, the token execution settings can vary amongst the queries based on different characteristics of the queries and be dynamically tailored to optimize balancing inference result accuracy and latency.

In another embodiment, a computing system, comprising at least one processor is provided that is configured to receive queries for processing by a transformer model in association with processing tokenized representations of respective input data samples of the queries, the tokenized representations comprising respective initial token numbers of execution tokens. The computing system is further configured to assign the queries into different batches respectively comprising different subsets of the queries.

For each batch of the different batches the computing system further determines a token adaptation number for respective execution tokens of respective queries included in the batch based on one or more characteristics of the queries included the batch. The one or more characteristics can include a first characteristic relating to input data sample content, a second characteristic relating to a query task, a third characteristic relating to a utility value, and a fourth characteristic relating to a latency requirement. The computing system if further configured to direct the transformer model to apply token adaptation number to adjust or maintain respective initial token numbers of the respective execution tokens in association with applying the batch as input to the transformer model. The computing system is further configured to apply the batch as input to the transformer model, configured to apply the token adaption number to adjust or maintain the respective initial token numbers of the respective execution tokens in association with applying the batch as input to the transformer model, to generate inference results for the queries included in the batch.

In this regard, based on the token adaptation number being greater than a threshold number, the transformer model, configured according to the token adaptation number, adds one or more prompt tokens to the respective execution tokens. Based on the token adaptation number being less than the threshold number, the transformer model, configured according to the token adaptation number, reduces the respective initial token numbers using a token merging process. Based on the token adaptation number being equal to the threshold number, the transformer model, configured according to the token adaptation number, maintains the respective initial token numbers. To this end, based on adding the one or more prompt tokens, an accuracy level of the inference results is increased for the batch, and based on reducing the initial token number, a latency level of the transformer model is decreased in association with the processing of the batch.

In one or more embodiments, the batching involves assigning the queries into the different batches by grouping similar queries having a similar characteristic in a same batch in accordance with a defined similarity criterion or a defined similarity metric, and wherein the similar characteristic is selected from a group comprising: a first characteristic relating to an arrival time of the queries, a second characteristic relating to a query task, a third characteristic relating to a utility value, and a fourth characteristic relating to a latency requirement. The computing system can further determine an execution order for the different batches based on arrival times of different queries included in the different batches, store the different batches in a batch queue, and apply the transformer model to the different batches sequentially in accordance with the execution order.

In some implementations, the computing system can also determine the token adaptation number for respective execution tokens of respective queries included in the batch based on a query load of the batch queue.

In some embodiments, elements described in connection with the disclosed systems can be embodied in different forms such as a computer-implemented method, a computer program product, or another form.

### DESCRIPTION OF THE DRAWINGS

FIG. 1 illustrates a block diagram of an example, non-limiting computing system that facilitates elastic transformer serving via token adaptation, in accordance with one or more embodiments of the disclosed subject matter.

FIG. 2 illustrates an example transformer model that incorporates token prompting and token merging, in accordance with one or more embodiments of the disclosed subject matter.

FIG. 3A illustrates a high-level transformer serving process in accordance with model adaptation techniques.

FIG. 3B illustrates a high-level transformer serving process in accordance with the disclosed token adaptation techniques, in accordance with one or more embodiments of the disclosed subject matter.

FIG. 4 illustrates prompt learning for transformer models in accordance with one or more embodiments of the disclosed subject matter.

FIG. 5 illustrates an example token merging mechanism in accordance with one or more embodiments of the disclosed subject matter.

FIG. 6 illustrates an example process for registering tasks and generating task parameters and task profile data, in accordance with one or more embodiments of the disclosed subject matter.

FIG. 7 illustrates an example elastic transformer serving process via token adaptation, in accordance with one or more embodiments of the disclosed subject matter.

FIG. 8 illustrates an example batching process, in accordance with one or more embodiments of the disclosed subject matter.

FIG. 9 illustrates an example token adaptation process, in accordance with one or more embodiments of the disclosed subject matter.

FIG. 10 illustrates another example token adaptation process, in accordance with one or more embodiments of the disclosed subject matter.

FIG. 11 illustrates another example elastic transformer serving process via token adaptation, in accordance with one or more embodiments of the disclosed subject matter.

FIG. 12 illustrates an example computer-implemented method for performing elastic transformer serving, in accordance with one or more embodiments of the disclosed subject matter.

FIG. 13 illustrates another example computer-implemented method for performing elastic transformer serving, in accordance with one or more embodiments of the disclosed subject matter.

FIG. 14 presents a table of the projection function from arriving rate to token adaptation number in accordance with an example implementation of the disclosed online token adaptation system (OTAS).

FIG. 15 presents a table of the latency and utility of queries in accordance with an example implementation of the disclosed OTAS.

FIGS. 16A and 16B present query trace graphs of different datasets in accordance with an example implementation of the disclosed OTAS.

FIGS. 17A and 17B present utility comparison graphs of different transformer serving system designs on different datasets.

FIGS. 18A and 18B present utility comparison graphs of different transformer serving methods on different datasets.

FIGS. 19A and 19B presents cumulative distribution function (CDF) graphs of the accuracies of different elastic transformer serving methods on different datasets.

FIGS. 20A and 20B present pie charts illustrating the distribution of different token adaptation numbers used in accordance with example implementation of the disclosed OTAS on different datasets.

FIGS. 21A and 21B present graphs comparing ratios of execution information for different transformer serving methods on different datasets.

FIG. 22 illustrates an example, non-limiting operating environment in which one or more embodiments described herein can be facilitated.

FIG. 23 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

In one or more embodiments, systems, computer-implemented methods, apparatus and/or computer program products are described that facilitate an elastic transformer serving system via token adaptation, referred to herein as an online token adaptation system (OTAS). A token is a basic unit of an input data sample to be proceeded by a transformer model, such as a unit of text, code, or a patch of an image. A transformer models splits the input data sample of an input query into input tokens (e.g., corresponding to different patches of an input image, different words in an input text prompt or the like) and processes these tokens with an attention mechanism, which calculates the similarity (i.e., attention weight) between the input query and key, and projects the attention value with the similarity weight to get a new representation. One of the key properties of the transformer model attention mechanism is its ability to support token sequences of varying lengths.

Motivated by this property, the disclosed OTAS employs a novel token adaptation technique that involves dynamically adjusting the execution tokens of the transformer model to improve service quality with negligible training costs. More specifically, the token adaptation technique involves adding prompting tokens to improve inference accuracy of the transformer model and removing redundant tokens to accelerate inference speed of the transformer model. The OTAS is designed to handle incoming request queries to be processed by the transformer model with varying arrival times, inputs, tasks, utilities, and latency requirements. In various embodiments, the OTAS tailors the token adaptation settings applied by the transformer model for respective request quires based on respective characteristics of the queries (e.g., arrival times, input tasks, utilities and/or latency requirements), as well as fluctuating query loads. In additional embodiments, to further improve service quality in view of fluctuating query loads and diverse user requests, the OTAS uses application-aware selective batching in combination with online token adaptation. In an example embodiment, the OTAS first batches incoming queries with similar service-level characteristics to improve the ingress throughput. Then, to strike a trade-off between the overhead of token increment and the potential for inference result accuracy improvement, the OTAS adaptively adjusts the token execution settings for the respective batches by solving an optimization problem rooted in balancing increasing accuracy and decreasing transformer model processing latency.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

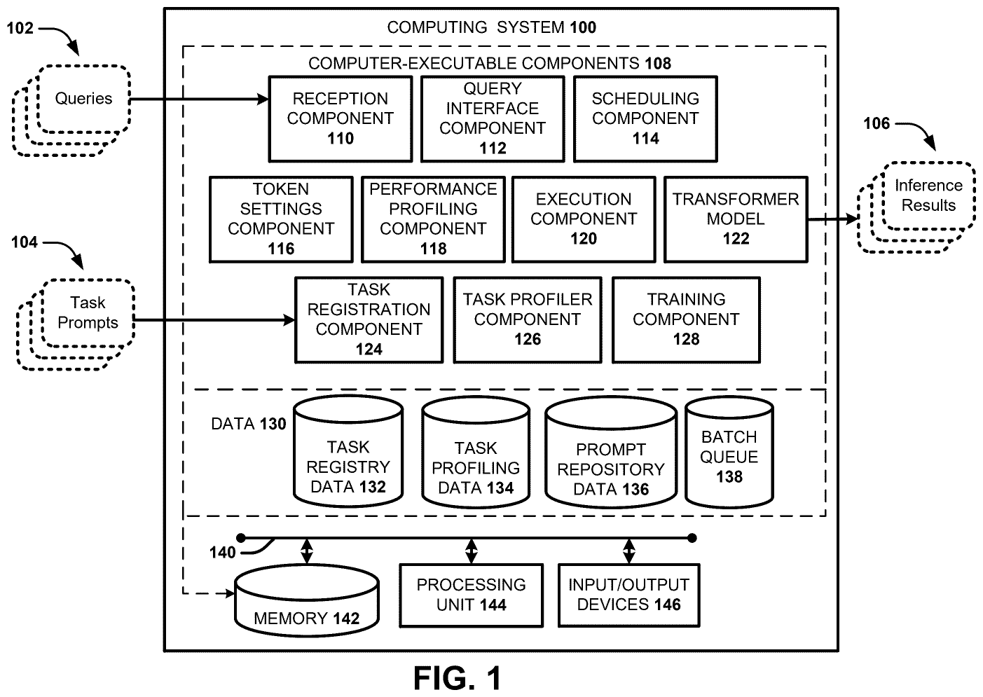

Turning now to the drawings, FIG. 1 illustrates a block diagram of an example, non-limiting computing system 100 that facilitates elastic transformer serving via token adaptation, in accordance with one or more embodiments of the disclosed subject matter. Computing system 100 can include or correspond to one or more computing devices, machines, virtual machines, computer-executable components, datastores, and the like, that may be communicatively coupled to one another either directly or via one or more wired or wireless communication frameworks.

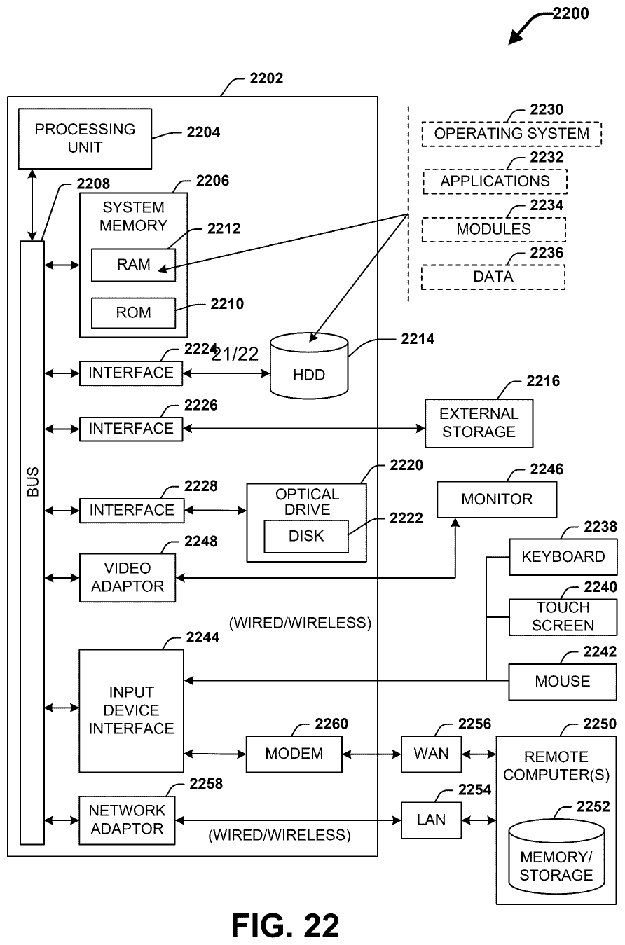

Computing system 100 can include computer-executable (i.e., machine-executable) components or instructions embodied within one or more machines (e.g., embodied in one or more computer-readable storage media associated with one or more machines) that can perform one or more of the operations described with respect to the corresponding components. For example, computing system 100 can include (or be operatively coupled to) at least one memory 142 that stores computer-executable components 142 and at least one processor (e.g., at least one processing unit 144) that executes the computer-executable components 108 stored in the at least one memory 142. These computer-executable components can include, (but are not limited to), reception component 110, query interface component 112, scheduling component 114, token settings component 116, performance profiling component 118, execution component 122, transformer model 122, task registration component 124, task profiler component 126 and training component 128. Memory 142 can also store data 130 that is received by, used by and/or generated by the computer executable components 108 to facilitate the operations described with respect thereto (e.g., task registry data 132, task profiling data 134, prompt repository data 136, and batch queue 138). In various embodiments, the processing unit 144 includes or corresponds to a graphics processing unit (GPU) or a tensor processing unit (TPU). Additional examples of said memory 142 and processing unit 144 as well as other suitable computer or computing-based elements, can be found with reference to FIG. 22 (e.g., system memory 2206 and processing unit 2204 respectively), and can be used in connection with implementing one or more the components shown and described in connection with FIG. 1, or other figures disclosed herein.

Computing system 100 can further include one or more input/output devices 146 to facilitate receiving user input and rendering data to users in association with performing various operations described with respect to the machine-executable components 108 and/or processes described herein. Suitable examples of the input/output devices 146 are described with reference to FIG. 22. Computing system 100 can further include a system bus 140 that couples the memory 142, the processing unit 144 and the input/output devices 146 to one another.

In accordance with various embodiments, computing system 100 can be configured to receive queries 102 (e.g., via reception component 110) to be processed by the transformer model 122 and execute the transformer model 122 on the queries 102 (e.g., via execution component 120 and processing unit 144) to generate inference results corresponding to the respective queries. In various embodiments, the computing system 100 can include or correspond to a cloud-based server that hosts (e.g., stores in memory 142) and executes (e.g., via processing unit 144 and execution component 120) the transformer model 122. To this end, the computing system 100 can receive queries 102 from multiple user devices via any suitable wired or wireless communication network and return the corresponding inference results 106 to the respective user devices via the wired or wireless communication network.

In some embodiments, the query interface component 112 can facilitate receiving queries 102 by the computing system 100. For example, the query interface component 112 can provide a user interface (e.g., a graphical user interface) that can be presented to users (e.g., as rendered via their respective user devices) that enables users to enter and submit request queries to be processed by the transformer model 122.

In various embodiments, the transformer model 122 can include a pre-trained transformer model (e.g., GPT-2, GPT-3, GPT-4 and various other non-proprietary and proprietary pre-trained GPTs) configured to perform a variety of different inferencing tasks. For example, in some embodiments, the transformer model 122 can include or correspond to a large language model (LLM). A large language model (LLM) is a type of GPT designed to understand, generate, and manipulate human language. These models are built using advanced machine learning techniques, particularly deep learning, and are trained on vast amounts of text data. LLMs, such as ChatGPT and others have demonstrated remarkable success in various natural language processing tasks, such as text generation and question answering. For example, LLMs can generate coherent and contextually relevant text based on a given an input request, such as a prompt or question provided in natural human language, making them useful for writing essays, articles, stories, and more. LLMs can also answer questions by extracting and synthesizing information from the text on which they have been trained. For example, as applied to one usage scenario in the medical domain, an LLM trained vast amounts of clinical text data can analyze patient electronic health records (EHRs) to and answer questions related to the patient's medical history in association with using natural language processing (NLP) to extract relevant information from unstructured text in the patient's EHR.

In other embodiments, the transformer model 122 can include or correspond to a pre-trained GPT that has been fine-tuned or specifically designed to generate computer code. These models can understand natural language prompts and generate corresponding code in various programming languages, such as Python, JavaScript, C++, and others. These models can be used to perform various different inferencing tasks, such as transforming natural language into code, code completion (e.g., automatically completing code lines given an input code snippet), code explanation (e.g., explaining the function of a piece of input code) and other tasks.

Still in other embodiments, the transformer model 122 can include or correspond to a pre-trained GPT adapted or extended to handle tasks related to image generation, manipulation, or understanding. These types of GPTs are typically referred to as a vision transformer. For example, the tasks can include text-to-image generation (e.g., generating images from textual description inputs), image captioning or image classification (e.g., taking an image as input and generating a textual description of what the image depicts), image style transfer or adaptation (e.g., changing an input image to appear to have a particular style, image quality or the like), and various other applications or tasks.

The transformer model 122 can also include or correspond to a pre-trained GPT adapted to handle tasks related to processing other forms of input data (e.g., audio data, video data, sensor data, etc.) and generate output data in various formats (e.g., text, image, audio, code, etc.). Still in other embodiments, the transformer model can include or correspond to a multi-model GPT that can process and generate data in multiple modalities, such as text, images, audio, and more. Unlike traditional GPT models, which are primarily text-based, multimodal GPTs are designed to handle inputs and outputs that span different types of data, allowing for more complex and versatile interactions and tasks.

To this end, regardless of the type of the transformer model 122 and the type of input data (e.g., corresponding to the input data included in the queries 102) and output data (e.g., corresponding to the inference results 106) the transformer model 122 has been pre-trained to process and generate, the transformer model 122 can be configured to perform a variety of different tasks associated different queries. In accordance with the disclosed techniques, the computing system 100 is designed to optimize the accuracy (e.g., increase and/or maintain) of the inference results 106 generated by the transformer model 122 in usage scenarios in which the queries 102 vary with respect to characteristics including but not limited to, the particular tasks requested for performance by the transformer model 122 represented by the respective queries 102, the particular input data content of the respective queries 102 (e.g., with respect to amount and type of input data), utility rewards associated with the queries (e.g., corresponding to a measure of some gain attributed to serving the respective requests, such as a monetary gain or the like, which can vary for different queries), and latency requirements associated with the respective queries (e.g., corresponding to a latency constraint of the respective queries, which can vary for different queries). At the same time, the computing system 100 is also designed to optimize the inferencing speed or latency of the computing system 100 in association with processing the queries 102 to generate the corresponding inference results 106, particularly in scenarios in which the transformer model 122 is being used to processes a large number of queries (e.g., hundreds, thousands, etc.) received simultaneously or substantially simultaneously at high influx rate (e.g., hundreds to thousands of queries 102 per second, or the another influx rate on), thereby increasing the overall online serving throughput of the computing system 100 over any given serving period. The computing system 100 is also designed to handle varying query loads over time. In this context, the computing system 100 is also designed to adapt to varying query loads in association with balancing improving or maintaining inference result accuracy and minimizing latency while accounting for varying service characteristics of the queries 102.

To facilitate this end, the computing system 100 employs a novel technique referred to token adaptation motivated by a key property of transform models, that is the attention mechanism employed and its ability to support token sequences of varying lengths. In this regard, in general, all transformer models (e.g., including transformer model 122 employed by the computing system 100) work by initially splitting the input data of a received queries into smaller pieces and converting the pieces into tokens, a process referred to as tokenization. For example, as applied to input text, the tokens include smaller units of the input text, typically words, subwords, or characters, depending on the tokenizer used. For example, the sentence “Transformers are powerful” might be tokenized into [“Transformers”, “are”, “powerful”] or subword tokens like [“Transform”, “ers”, “are”, “power”, “ful”]. In another example, as applied to an input image, the tokens include fixed-sized patches of the input image. In other words, a token is a basic unit of an input data sample to be proceeded by a transformer model 122, such as a unit of text, code, or a patch of an image. The number of input tokens generated for a given input data sample included in a query can vary based on the content of the input data sample (e.g., number of words, size of the image, etc.). Thus, the attention mechanism of the transformer model 122 can process input token sequences of varying lengths.

In some implementations, the tokenization process can be integrated into the transformer model 122. In other implementations, the tokenization process can correspond to a pre-processing step performed by the reception component 110 on the queries 102 as received by the computing system 100. In this regard, the transformer model 122 is configured to process tokenized representations of respective input data samples of the queries 102, the tokenized representations respectively comprising a number of tokens, wherein the number varies depending on the content of the input data samples and the data type or types included in the input data samples (e.g., text data, image data, code data, audio data, sensor data, etc.).

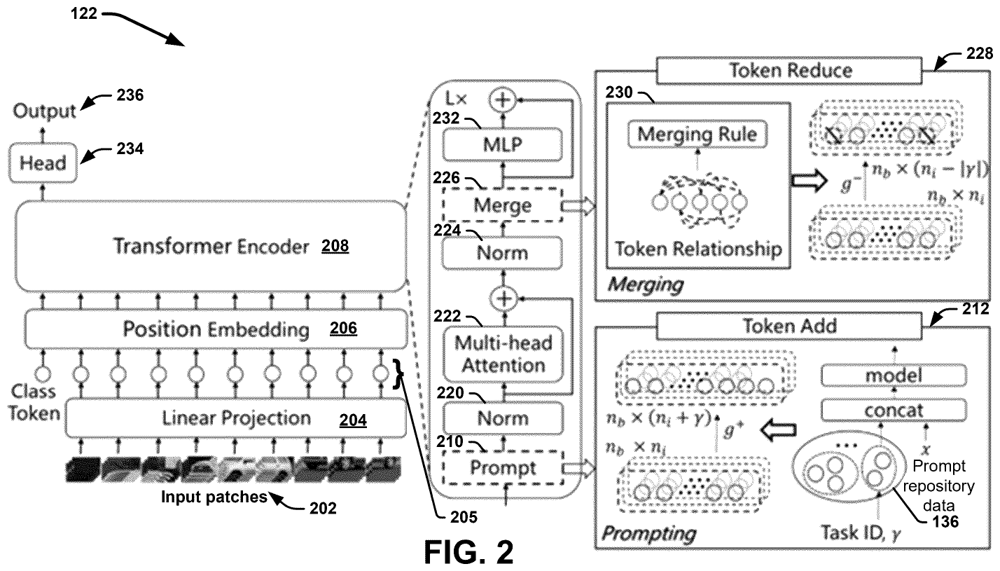

For example, FIG. 2 illustrates an example of the transformer model 122 in accordance with one or more embodiments of the disclosed subject matter. In this example, the transformer model 122 is configured to process a tokenized representation of an image to generate a corresponding to an inference result (e.g., corresponding to output 236). The particular inferencing task to be performed on the input image by the transformer model 122 can vary. For example, the inference result may correspond to a classification of an object in the input image, a text description of what the input image depicts, a modified version of the input image, and so on. It should be appreciated that although the transformer model 122 is exemplified in FIG. 2 as being a vision transformer, that the transformer model 122 is not restricted to being a vision transformer and can correspond to a GPT configured to process various types of input data and generate various types of output data.

With reference to FIGS. 1 and 2, as illustrated in FIG. 2, the input image is split into patches (e.g., input patches 202) and the patches are transformed into a sequence of tokens 202 by the transformer model 122 via linear projection performed by a linear projection layer 204. More particularly, after an input data sample of a query has been split into tokens (e.g., tokens 705), the transformer model 122 maps each token to a dense vector representation known as an embedding. These embeddings are learned during training and capture the semantic meaning of tokens in a continuous vector space. Since transformers lack inherent sequence information (unlike recurrent neural networks (RNNs)), positional encodings are added to the token embeddings (e.g., via position embedding layer 206) to introduce information about the token positions within the sequence. This allows the model to understand the order of tokens.

The core of the transformer model is the self-attention mechanism. It allows the model to weigh the importance of each token relative to others in the sequence, regardless of their distance from each other. Generally, the attention mechanism is performed by an encoder neural network of the transformer (i.e., transformer encoder 208) which calculates the similarity (i.e., attention weight) between the input query (represented by the tokens) and key, and projects the attention value with the similarity weight to get a new representation. More particularly, for each token, the transformer model computes three vectors: Query (Q), Key (K), and Value (V). These vectors are obtained by multiplying the token embeddings with learned weight matrices. The Query vector of a token is compared with the Key vectors of all tokens in the sequence to compute attention scores (dot products). These scores determine how much focus each token should have on the others. The attention scores are passed through a softmax function to normalize them into probabilities. The final representation for each token is a weighted sum of the Value vectors, where the weights are the attention probabilities.

In this regard, to capture different types of relationships and patterns in the data, the transformer model uses multiple attention heads. For example, as illustrated in FIG. 2, the transformer encoder 208 is stacked by a number of attention blocks, which can include normalization layers (e.g., normalization layer 220 and normalization layer 224), a multi-head attention layer 222, and a multilayer perception (MLP) layer 232. As illustrated in FIG. 2, in addition to these layers, the transformer encoder 208 of transformer model 122 also include a prompting layer 210 prior to the multi-head attention layer 222 and a merging layer 226 inserted between the multi-head attention layer 222 and the MLP layer 232. These two additional layers are described in greater detail infra.

The multi-head attention layer 222 allows the model to extract features from different representation spaces, and each space is called an attention head i. In attention, there are a query Q, a key K, and a value V, and Q, K, V∈ [symbol] ^{n×d}^{_{model}}, where n is the sequence length of tokens and d_{model} is the feature dimension. As shown in Equation (1) below, the Q, K and V are first mapped to a low-dimension space with the projection parameters. Then, the model uses the attention mechanism to model the interactions between tokens and extract the semantic features in accordance with Equation (2).

$${head}_{i} = Attn ( {QW}_{i}^{Q} , {KW}_{i}^{K} , {VW}_{i}^{V} ) . \qquad Equation 1$$

$$Attn ( {Q}_{i} , {K}_{i} , {V}_{i} ) = softmax ( \frac{{Q}_{i} {K}_{i}^{T}}{\sqrt{{d}_{k}}} ) {V}_{i} . \qquad Equation 2$$

In accordance with Equation 2, the attention weights between the query Qᵢ and the key Kᵢ are first calculated, and then applied to Vito get a new representation. Qᵢ, Kᵢ, ∈ [symbol] ^{n×d}^{ᵥ}, and dₖ, dᵥ are the feature representations. In self-attention, Q, K and V are equal to the input x at each layer. Each attention head of the multi-head attention layer 222 independently performs the self-attention process with its own learned weights. The outputs of all the attention heads are concatenated by the multi-head attention layer 222 to generate a concatenated attention head. The concatenated attention head is further processed by a linear module (not shown), and the output of the multi-head attention layer is forwarded to the subsequent block.

In this regard, in accordance with conventional transformer models, after the multi-head attention layer 222, each token's representation is normalized (e.g., via normalization layer 224) and passed through a feedforward neural network (FFN) referred to as the MLP layer 232. The MLP layer typically consists of two linear transformations with a non-linear activation in between. This step introduces non-linearity and further refines the token representations. To improve the flow of gradients during training and stabilize learning, the transformer model uses residual connections. The input to each sub-layer (like self-attention or FFN) is added to its output. After the residual connection, layer normalization is applied to normalize the output, ensuring that the model remains stable during training.

The output of the transformer encoder 208 is a set of contextually enriched token representations represented by head 234, where each token's vector has been adjusted to include information from all other tokens in the sequence. The inference output 236 is generated by the transformer model 122 by processing the final contextualized token representations, which varies based on the particular task involved. For example, in tasks like machine translation or text generation, the final token representations are passed to a decoder (in an encoder-decoder model) or used directly to predict the next token in the sequence.

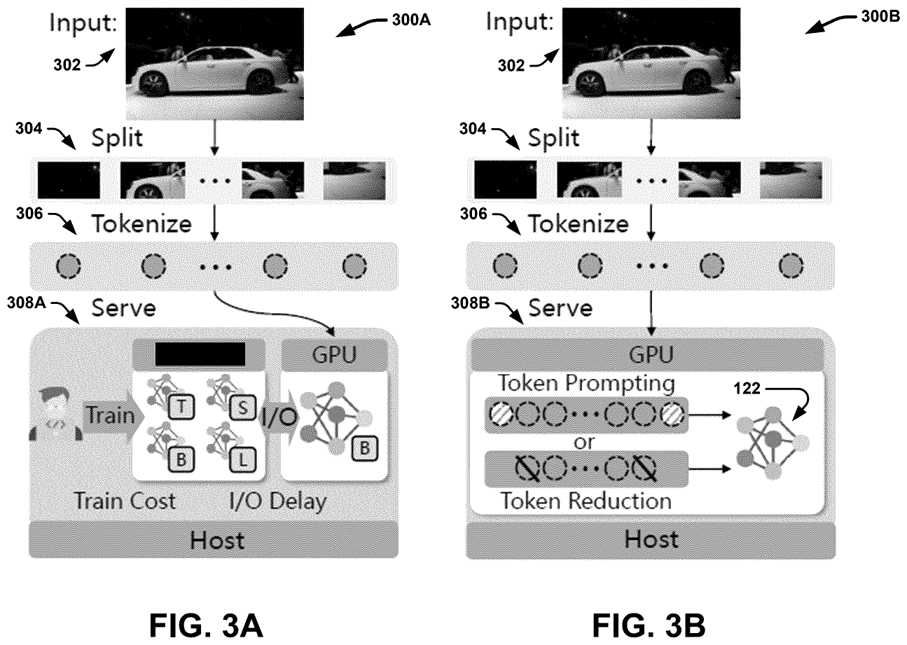

As noted in the Background Section, an existing technique used to improve the service quality provided by cloud-based transformer model hosting and execution systems in association with accounting for different queries and service demands involve model adaptation. A high-level overview of the model adaptation process is illustrated in FIG. 3A.

With reference to FIG. 3A in view of FIG. 1, FIG. 3A illustrates a high-level transformer serving process 300A in accordance with model adaptation techniques. Process 300A is exemplified as applied to serving a vision transformer model configured to process an input image 302 to perform a particular requested inferencing task on the input image such as object classification or another task indicated in the query. As described above, the input image is initially split into patches at 304 and the patches are tokenized at 306. The input tokens are further processed by the attention head mechanism of the transformer model hosted by the serving system at 308A. As indicated in FIG. 3A, the model adaptation technique used by the hosting system at 308A involves training multiple model variants of a foundation (i.e., pre-trained) transformer model (indicated with letters T, S, B and L) with different sizes to accommodate varying service demands. These multiple model variants are stored by the serving system and dynamically selected and applied to accommodate the variations in query load during runtime. For example, at 308A in process 300A, the B variant of the transformer model has been selected for processing the input tokens.

Unfortunately, this technique is not suitable for large transformer models because training these models can be prohibitive in terms of high monetary costs and time overhead. In addition, loading such kind of model to the serving system processing unit (e.g., a graphics processing unit (GPU) or the like) for execution may take several seconds, which can add up to huge latency costs attributed to input/output delay (I/O) delay as used to serve a large number of user queries (hundreds, thousands, millions, etc.) even over a relatively short serving period (e.g., thirty minutes or so). Moreover, the size of different transformer models varies significantly, and it is hard to prepare different fine-grained model versions tailored to different inferencing tasks.

FIG. 3B illustrates a high-level transformer serving process 300B in accordance with the disclosed token adaptation techniques, in accordance with one or more embodiments of the disclosed subject matter. For ease of comparison to process 300A, process 300B is also exemplified as applied to serving a vision transformer model configured to process input image 302 to perform the particular requested inferencing task on the input image such as object classification or another task indicated in the query. As with process 300A, the input image is split into patches at 304 and tokenized at 306. However, at 308B, the hosting system (e.g., corresponding to computing system 100) employs a unified transformer model (e.g., transformer model 122) to process the input tokens. In this regard, instead of training multiple different models from scratch and selecting an applying a particular model tailored to the input query, the hosting system can employ a large, pre-trained model that has been particularly configured to perform a novel token adaptation technique in order to minimize latency, I/O delays and serve queries with diverse characteristics (e.g., with respect to input content, task, utility reward and latency requirements), and fluctuating query loads a runtime (i.e., online). To this end, the hosting/serving system which corresponds to computing system 100, is referred to herein as an online token adaptation system (OTAS).

As indicated in FIG. 3B, the token adaptation technique involves a token prompting process and/or token reduction (also referred to herein as token merging process). As illustrated in FIG. 2, in addition to the conventional transformer layers and processing mechanisms discussed above for transformer models in general, the transformer model 122 used by computing system 100 includes an additional prompting layer 210 configured to perform the token prompting process (e.g., process 212 in some embodiments) and an additional merging layer 226 configured to perform the token merging process (process 228 in some embodiments).

With reference to FIGS. 1, 2 and 3B, generally, the token prompting process 212 performed by the prompting layer 210 involves adding one or more prompting tokens to the initial tokens generated for the input data sample via tokenization that are fed as input to the transformer encoder 208. The added prompting tokens can be used to improve the accuracy of the corresponding inference result generated by the transformer model 122 as tailored to a requested inferencing task. However, the added prompt tokens can increase the processing latency (or decrease the processing speed) by the transformer model 122. On the other hand, the token merging process 228 performed by the merging layer 226 removes unnecessary tokens from the initial input tokens that have little or no impact on inference result accuracy. The reduced number of tokens equates to a reduction in processing latency (or an increase in processing speed) by the transformer model 122.

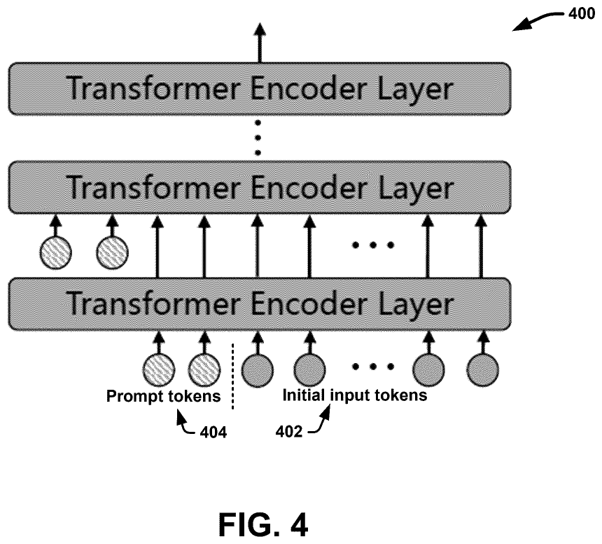

FIG. 4 illustrates the concept of token prompting for transformer models in accordance with one or more embodiments of the disclosed subject matter. With reference to FIGS. 1-4, FIG. 4 presents a simplified view of a transformer encoder 400 of general transformer models. Token prompting involves adding pre-trained (and predefined) prompt tokens 404 to the initial input tokens 402 (e.g., the initial tokens generated via tokenization of the input data). The combined prompt tokens 404 and initial input tokens 402 form the runtime execution tokens that are concatenated and forwarded to the transformer encoder layers to conduct multi-head attention. The prompt tokens correspond to task specific cues that are used to add context to the query and model input to guide the output response. In this regard, the prompt tokens are carefully designed to elicit specific types of response or outputs by the transformer model. For example, suppose the transformer model corresponds to an LLM and a user want to use the LLM to generate query a product description for an online store. A token-prompted input might be: Input: “Product: Wireless Bluetooth Headphones. Description: These headphones are [excellent/poor] for music lovers because . . . ”, wherein the prompt token corresponds to an added token for either the word excellent or poor. In this regard, depending on the word/prompt token inserted (e.g., “excellent”), the model will continue with a positive description, while “poor” might lead to a negative one.

In accordance with the disclosed techniques, the prompt tokens are initialized randomly and trained (e.g., via training component 128) using stochastic gradient descent. During inference, well-trained prompt tokens can be directly prepended to the initial input tokens as defined for a particular inferencing task (and model output response to be elicited) by the transformer encoder 208 via the added prompting layer 210, as discussed in greater detail below.

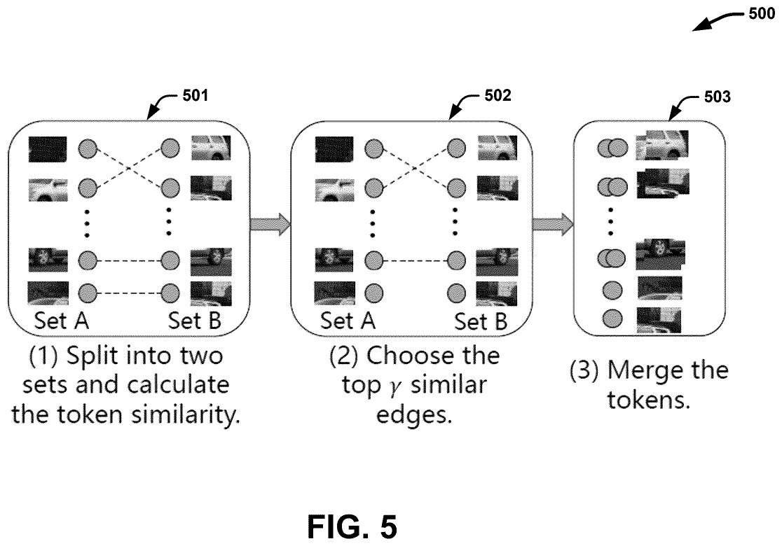

FIG. 5 illustrates the concept of token merging for transformer models in accordance with one or more embodiments of the disclosed subject matter. Generally, token merging involves removing redundant or unnecessary tokens which accelerates inferencing speed. With reference to FIGS. 1-5, in various embodiments, the token merging process 228 performed by the merging layer 226 involves merging similar tokens together using a token merging method. FIG. 5 illustrates an example token merging method 500 that can be used by the merging layer 226 to reduce the number of tokens. In accordance with token merging method 500, at 502, the tokens are split into two sets, referred to as set A and set B, and the similarities between the two sets are calculated using a defined similarity metric. At 504, assuming a constraint has been defined (e.g., by the token settings component 116) indicating a number of tokens to be removed from the initial input tokens the second step at 502 is to keep only γ edges with the highest similarity values. Finally, at 503 similar tokens are merged using a weighted average and concatenated into a new sequence.

Although token merging reduces the number of tokens and thus decreases the processing latency of the transformer model 122, as the number of tokens is decreased, the accuracy of the model can also decrease. The amount to which the accuracy is decreased can vary based on the input data sample content and the inferencing task involved, which can vary significantly amongst the queries 102 received. In this regard, it is hard to determine a suitable merging ratio to be applied that accounts for respective request inputs, as well as the query load and computational resources of the computing system 100. Likewise, the disclosed token adaptation technique can be used to evaluate how different numbers of prompt tokens influence the output accuracy and throughput or latency of the transformer model, e.g., and, as a result, find the accuracy gains for different numbers of prompt tokens vary for different tasks. Understandably, as the number of prompt tokens is increased, there is a declining trend in serving throughput.

Thus, to fully leverage the benefits of adding prompt tokens and merging tokens, the disclosed token adaption technique dynamically determines (e.g., via token settings component 116 and performance profiling component 118) optimal token execution settings regarding the number of prompt tokens to be added by the prompting layer 210 and/or the number of tokens to be removed by the merging layer 226 for the respective queries 102 that balances improving or maintaining a desired accuracy level and minimizing processing latency of the transformer model for the incoming queries 102 that align with the request burden, task type, and service characteristics associated with the queries 102 as well as the hardware resources of the computing system 100 (e.g., in terms of memory 142 constraints and processing unit 144 constraints). In other words, the token adaptation technique employed by the computing system 100 can adapt the initial token number generated for respective input data samples of the queries via tokenization via token prompting and/or token merging as tailored to respective characteristics of the queries (which can vary), the fluctuating query loads, and the resource constraints of the computing system 100. As noted above, the characteristics of the query quests that are considered in this dynamic assessment include but are not limited to: the particular tasks requested for performance by the transformer model 122 represented by the respective queries 102, the particular input data content of the respective queries 102 (e.g., with respect to amount and type of input data), utility rewards associated with the queries (e.g., corresponding to a measure of some gain attributed to serving the respective requests, such as a monetary gain or the like, which can vary for different queries), and latency requirements or constraints associated with the respective queries.

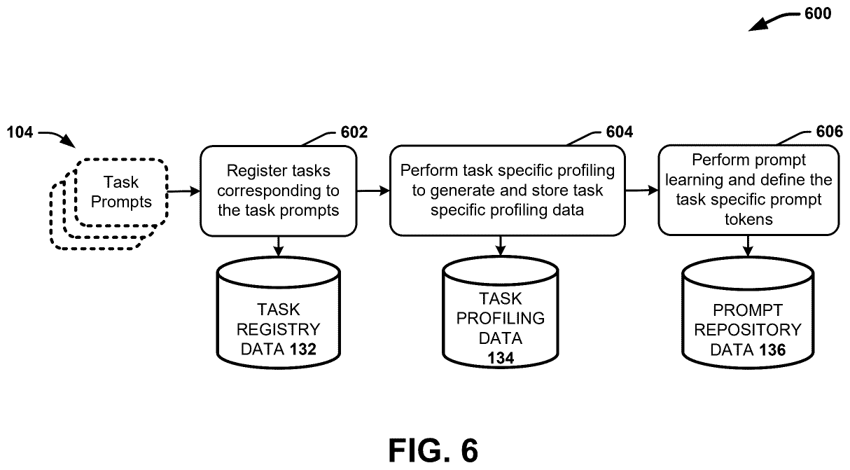

To facilitate this end, the computing system 100 employs an initiation process to first understand and define how different token adaptation settings involving token prompting and token merging with different number of tokens added and removed as used for request queries corresponding to the request queries 102 impact inference result accuracy by the transformer model 122 and latency of the transformer model for different defined task types. This involves registering different task types and generating task registry data 132 (via task registration component 124), generating task profiling data 134 (e.g., via task profiler component 126) and generating prompt repository data 136 (e.g., via training component 128), as described in greater detail with reference to FIG. 6.

In this regard, FIG. 6 illustrates an example process 600 for generating task registry data 132, task profiling data 134 and prompt repository data 136, in accordance with one or more embodiments of the disclosed subject matter. With reference to FIGS. 1-6, in various embodiments process 600 corresponds to an offline process that is performed prior to serving the transformer model 122 online by the computing system 100.

Process 600 begins at 602, wherein tasks corresponding to received task prompts 104 are registered with the computing system 100. This involves receiving user input (e.g., from a model developer or the like) via a corresponding task registration user interface provided by the task registration component 124. The received user input includes respective task prompts 104 corresponding to different types of inferencing tasks that can be performed by the transformer model 122 and assigning each task prompt a unique task identifier (ID). The user input received in association with registering respective tasks at 602 can also include developer defined task-specific parameters, including a required or preferred token number for the task, a latency constraint or requirement for the task and a utility value associated with the task. In some implementations, the user input can also define one or more task prompting tokens that can be used for the task type as ranked in order of preferred usage by the prompting layer 210. All of this information is stored in the task registry data 132. In this regard, the task registry data 132 can include or correspond to an index or table identifying a plurality of different task types. Each defined task type in the task registry data 132 includes a unique ID and defined parameters, including but not limited to: a required or preferred token number, a latency value associated with the task, a utility value associated with the task and one or more prompt tokens as ranked in order for usage by the prompting layer 210.

At 604, the task profiler component 126 performs task specific profiling to generate and store task specific profiling data 134 for the respective registered tasks. This can involve determining, via the task profiler component 126, for each registered task in the task registry data 132, how token merging and token prompting using different number of tokens removed and/or prompt tokens added, respectively, impacts inference output accuracy and processing latency of the transformer model 122 as executed by the computing system 100. In various embodiments, this can be achieved by applying the transformer model 122 to training queries corresponding to the task type in association directing the transformer model 122 to use different token settings corresponding to different combinations of adding different numbers of prompt tokens and/or removing different numbers of initial execution tokens, evaluating how the different token adaptation settings impact inference result accuracy and latency. In this regard, the task profiling data 134 can include information for each task that indicates how the different token adaptation settings impact inference accuracy and latency.

In some implementations of these embodiments, token adaptation settings can allow for either token merging or token prompting (but not both). With these implementations, the token settings component 116 can indicate whether to remove tokens, or add prompt tokens, and the corresponding amounts of tokens for removal or addition, as a function of a token adaptation number, indicated herein as gamma γ. The token settings component 116 can defined the token adaptation number γ, such that if γ is greater than a threshold number such as zero (e.g., γ<0), this corresponds to reducing the token number; if γ is greater than the threshold number (e.g., γ>0), this indicates adding one or more prompting tokens, and wherein if γ is equal to the threshold number (e.g., γ=0), this indicates performing no token adjustment (i.e., making the inference with initial number of execution tokens generated from the tokenization process. In other words, the value of the token adaptation number γ can be a discrete number that corresponds to a number of tokens to be removed from the initial execution tokens when the discrete number is a negative number, and such that the discrete number corresponds to a number of prompt tokens to be added to when the discrete number is a positive number. In some implementations, the token adaptation number γ can be a discrete value that can be selected from a pre-defined list of possible token adaptation numbers that may be used. For instance, in one or more implementations, the pred-defined list of possible token adaptation numbers can include {−20, −15, −10, −5, 0, 2, 4, 8}. In this regard, a token adaptation number of γ=−20 corresponds to removing 20 of the initial execution tokens, a token adaptation number of γ=−15 corresponds to removing 15 of the initial execution tokens, and so on. With these embodiments, the task profiling data 134 can include information for each task that indicates how different token adaptation values (i.e., γ values) impact inference accuracy processing latency of the transformer model 122 in association with processing batches of queries with different batch numbers.

With these embodiments, the task profiling data 134 can include information that indicates how different token adaptation numbers (i.e., γ values) impact inference accuracy and processing latency of the transformer model 122 in association with processing request queries of varying characteristics (e.g., varying task types, varying latency constraints, input data sample content, etc.). In various embodiments, this can be achieved by applying the transformer model 122 to training request queries having the varying characteristics in association directing the transformer model 122 to use different token adaptation numbers and evaluating how the different token number and query characteristics impact inference accuracy and processing latency of the transformer model 122 as executed by the computing device 102 (e.g., under the processing unit 144 and memory 142 capacities of the computing system 100).

Additionally, or alternatively, the task profiling data 134 can include information that indicates how different token adaptation numbers (i.e., γ values) impact inference accuracy and processing latency of the transformer model 122 in association with processing grouped batches of request queries of similar and varying characteristics (e.g., task types, latency constraints, input data sample content, etc.) and different batch sizes. In this regard, in one or more embodiments, as opposed to processing a single request query at a time, the transformer model 122 can be configured to perform batch processing. In the context of serving transformer models, a “batch” refers to a group of queries that are processed together in a single forward pass through the transformer model 122. Batching is commonly used in machine learning, including transformer models, to optimize computational efficiency and speed during inference or training. The batch size corresponds to the number of queries 102 that are processed together. Batching allows for the use of parallel processing on GPUs or other hardware accelerators, which are designed to handle multiple computations simultaneously. This increases the throughput (the number of inputs processed per unit of time) compared to processing each input individually. Larger batch sizes can increase memory usage by the computing system 100 because the model needs to store all the intermediate computations for each input in the batch. However, GPUs and TPUs are typically optimized to handle these parallel computations efficiently. In this context, latency refers to the time it takes to process all queries included in the same batch from start to finish. In accordance with batching for transformer models, all request queries included in the same batch use the same token adaptation number γ.

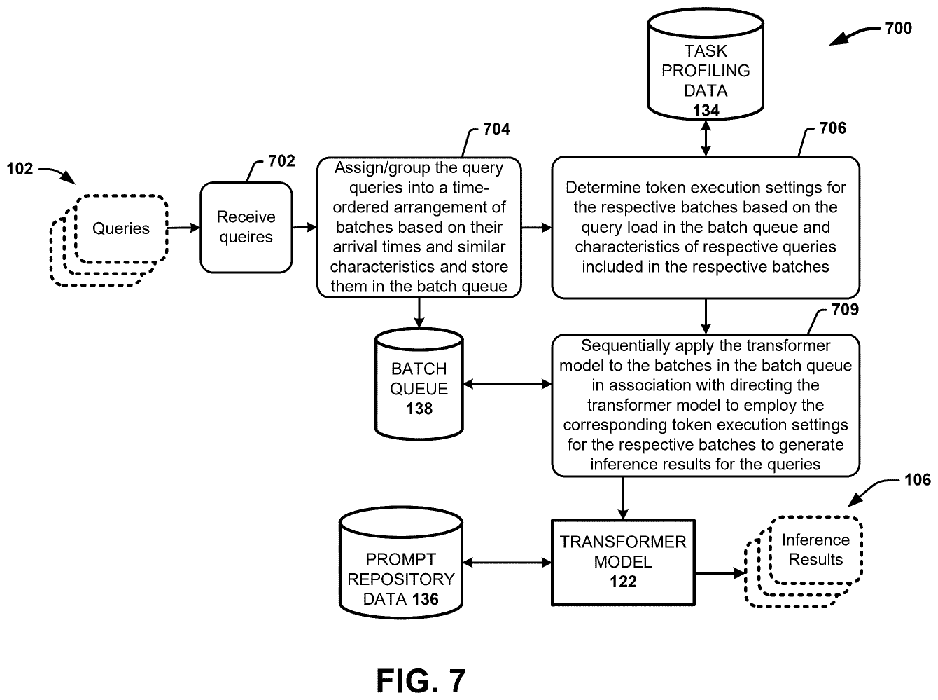

To this end, in some embodiments, at runtime, the scheduling component 114 can be configured to assign queries 102 into different batches respectively comprising different groups or subsets of queries. This involves assigning queries having similar characteristics (e.g., similar task types, similar input data, similar latency requirements and/or similar utilities) and similar arrival times together in the same batch. All batches are stored in the batch queue 138 in a time-ordered arrangement and are executed in order accordingly. As described in greater detail with reference to FIG. 7, the scheduling component 114 can employ an adaptive batching mechanism to adjust the sizes of the respective batches as tailored to have a desired impact on latency and throughput.

In this regard, with reference again to process 600, in accordance with batching embodiments, at 604, the task profiler component 126 can determine how different token adaptation numbers (i.e., γ values) used for a batched group of input queries influence accuracy and latency of the transformer model 122 (and/or the latency and throughput of the computing system 100 overall in association with serving queries) for different batch sizes and this information can be stored in the profiling data 134.

Process 600 also involves performing prompt learning at 606 to define the task specific prompt tokens which are stored in the prompt repository data 136. In this regard, The prompting tokens are trained offline via the training component 128 and stored in the prompt repository data 136. A token pair is associated with a task ID and a prompt number, which serves as its index. During training, the prompt repository data 136 is first initialized randomly and each token pair is trained separately. A token pair is acquired from the prompt repository data 136 at every training epoch concatenated with the initial input tokens.

As applied to batches, if the batch size is n_{b} and the input token length is nᵢ, the token shape becomes n_{b}×(nᵢ+γ) after prompting. The concatenated tokens can be forwarded to the next module. During inference, which is execution of the transformer model 122 online to respective batches if queries 102, the prompting layer 210 model uses the well-trained prompt parameters in the prompt repository data 136 directly to add prompting tokens corresponding to respective task types included in the batch.

FIG. 7 illustrates an example elastic transformer serving process 700 via token adaptation, in accordance with one or more embodiments of the disclosed subject matter. Process 700 corresponds to a runtime or online process that can be performed by the computing device 100 after generation of the task registry data 132, the task profiling data 134 and the prompt repository data 136. With reference to FIG. 7 in view of FIGS. 1-6, in accordance with process 700, at 702, the reception component 110 receives queries 102. It should be appreciated that under envisioned usage scenarios, the reception component receives a fluctuating stream of queries 102 at varying influx rates, ranging for example from anywhere to a single query per second (or a larger window of time) onwards to several hundreds or thousands of requests per second. In this regard, the received queries 102 have varying arrival times and characteristics (e.g., varying task types, varying input data sample content, varying latency requirements and varying utility values). In some embodiments, the queries 102 can be received with metadata that indicates their corresponding characteristics. For example, the respective queries can be received with metadata indicating their respective task identifiers, utility values, and latency requirements. In other embodiments, the reception component 110 can infer these characteristics based on their task type (as indicated via received task IDs or inferred) and using the task profile data 134.

At 704, the scheduling component 114 assigns or groups the queries into a time-ordered arrangement of batches (as received over time) based on their arrival times (or reception times) and similar characteristics and stores them in the batch queue 138. With these embodiments, the execution component 120 executes the transformer model 122 on the respective batches in the batch queue sequentially (e.g., in accordance with the time-ordered arrangement).

While batching has clear benefits on increasing throughput and decreasing latency, one challenge is to design an adaptive batching strategy that effectively groups similar queries together. In various embodiments, to achieve this, at 704, the scheduling component 114 can be configured to assign incoming queries into batches based on their similar arrival patterns and similar service-level objectives, such as similar latency constraints, utility values, processing completion deadlines and the like. For example, the assigning at 704 can comprise assigning the queries 102 as received into the different batches by grouping similar queries having a similar arrival time together in the same batch, under a maximum batch size constraint and/or a defined time constraint based on arrival time and completion deadline. The scheduling component 114 can also assign incoming queries to batches by grouping queries having one or more similar characteristic togethers (e.g., a same or similar task type, a similar arrival time, a similar latency requirement, and/or a similar utility value) in the same batch in accordance with a defined similarity criterion or a defined similarity metric.

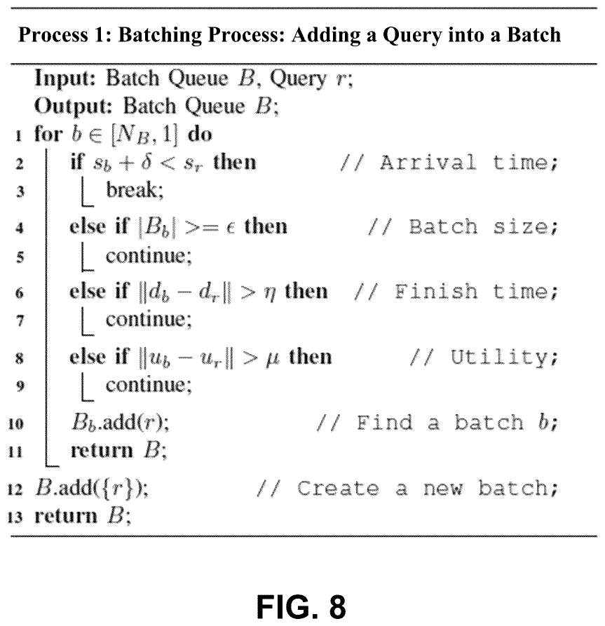

In one or more embodiments, to facilitate this end, the scheduling component 114 can batch the incoming queries 102 in accordance with the Process 1 illustrated in FIG. 8. With reference to FIG. 8 in view of FIGS. 1-7, in accordance with these embodiments, the notation r is be used to represent a query, where sᵣ, lᵣ, dᵣ, and uᵣ represent the request's arrival time, latency requirement, completion deadline, and utility value, respectively, such that dᵣ=sᵣ+lᵣ. The scheduling component 114 stores the grouped queries in the batch queue 138, Process 1 as B, as ordered for sequential execution in time based on the earliest arrival time of a query included in the respective batches. Process 1 denotes the b-th batch as B_{b}. In accordance with Process 1, the arrival time s_{b} of a batch b can be defined as the earliest arrival time sᵣ of a query included in the batch, i.e., s_{b}=min {sᵣ}, r∈B_{b}. Similarly, the completion deadline d_{b} of a batch b can be defined as the earliest completion deadline dᵣ among its requests, i.e., d_{b}=min {dᵣ}, r∈B_{b}.

In accordance with Process 1, the scheduling component 114 assigns a query to one of the current batches in the batch queue B or initializes/creates a new batch. The key idea of Process 1 is based on constructing a batch with constraints on batch size, arrival time, utility and deadline. More specifically, Process 1 ensures that the waiting time of the first request in a batch is less than a threshold duration δ, the batch size is smaller than a pr e-defined threshold size E, and the deadline difference between the batch and the query r is not larger than a deadline threshold n. Process 1 uses u_{b} to represent the utility of the first arrival query in a batch b, and restricts the utility value for subsequent incoming query r to be close to the value of u_{b} with a threshold μ. These constraints ensure that queries with similar arrival patterns and service-level objectives are processed together, which is beneficial for token adaptation. If a batch that meets the constraints for the incoming query is found, the query is added to that batch b (Line 1˜9 of Process 1). Otherwise, the scheduling component 114 creates a new batch for the query and adds the new batch to the batch queue B.

After one or more completed batches have been established in the batch queue 138, the next step is to assign token adaptation settings for the respective batches in the batch queue 138. Although grouped based on similar characteristics, the resulting batches in the batch queue 138 may contain queries requests corresponding to different tasks with varying utilities and latency requirements. In this regard, continuing with process 700, at 706 the token setting component 116 also determines token execution settings for the respective batches in the batch queue 138 characteristics of respective queries included in the respective batches (e.g., respective task types, utilities, latency requirements, completion deadlines, etc.). The scheduling component 114 can also determine the token execution settings for the respective batches in the batch queue 138 based on the query load in the batch queue (e.g., based on number of batches, respective sizes of the batches and/or respective latency constraints associated with the batches) and/or the load on the computing system 100 overall (e.g., also accounting for the rate of influx of incoming queries).

In various embodiments, the determining of the token settings for the respective batches in the batch queue 138 by the token settings component 116 at 706 involves for each batch of the different batches in the batch queue 138, determining a token adaptation number γ for adjusting or maintaining the respective initial (e.g., as generated via tokenization) execution tokens of respective queries included in the batch based on one or more characteristics of the queries included the batch. As noted above, as applied to batch processing, the token settings component 116 assigns the same token adaptation number γ for all queries included in the same batch. In this regard, the one or more characteristics can include (but are not limited to), input data sample content of the respective queries, respective tasks of the queries, respective utility values of the queries and respective latency requirements of the queries.

Generally, to facilitate this end, based on the respective characteristics of the respective queries in the batch and the task profiling data 134, the task profiling component 118 can estimate how the respective characteristics of the queries in a batch impact inference result accuracy for the batch and latency or inferencing time for the batch under different token adaptation settings (e.g., accounting for using token prompting alone, token merging alone, and/or a combination of token prompting and token merging). Additionally, or alternatively, based on the respective characteristics of the respective queries in the batch and the task profiling data 134, the task profiling component 118 can estimate how the respective characteristics of the queries in a batch impact inference result accuracy for the batch and latency or inferencing time for the batch under different token adaptation numbers γ. For example, a token adaptation number of γ>0 can be used to denote that the prompting layer 210 is to add a corresponding number of prompting tokens and a token adaptation number of γ<0 can be used to denote that the prompting layer merging layer 226 is merge a corresponding number of tokens to arrive at a γ number of tokens following the MLP layer 232.

Based on how the different token adaptation settings or token adaptation numbers for a batch influence inference result accuracy and/or processing latency of the batch, the token settings component 116 can further select an optimal token adaptation setting and/or a token adaptation number γ for the batch that balances increasing or maintaining inference output accuracy for the batch and decreasing latency. In this context, the token settings component 116 can also determine the token adaptation number γ for a batch in consideration of how the token adaptation number will influence the throughput of the transformer model 122 in association with processing all the batches in the batch queue 138. In other words, the token settings component 116 can tailor the token adaptation numbers γ for the respective batches in the batch queue 138 based on the query load of the batch queue, selecting a smaller token adaptation number when the load is high to increase throughput and selecting a larger token number when the load is low to increase accuracy.

In one or more embodiments, the token settings component 116 can formulate the task of determining the optimal token adaptation settings for the respective batches and/or the optimal token adaptation numbers for the respective batches as an optimization problem. In some implementations of these embodiments, the token settings component 116 can obtain the solution to the optimization problem (i.e., the token adaptation settings for the respective batches and/or the runtime execution numbers for the respective batches) using a dynamic programming process.

In some implementations of these embodiments, the token settings component 116 can define the token adaptation setting for a batch b as γb, where γb<0 indicates reducing the token number, γb>0 indicates adding one or more prompting tokens, and γb=0 indicates making the inference with initial number of execution tokens generated from the tokenization process. With these embodiments, the token adaptation number γ can be a discrete value that can be selected by the token execution settings 116 for a batch from a pre-defined list of possible token adaptation numbers that may be used (e.g., as defined in the task profiling data 134). For example, the possible values may include the same distribution of different γ values evaluated for respective training request queries and/or training batches by the task profiler component 126 at 604 in the offline process 600. For instance, in one or more implementations, the pred-defined list of possible token adaptation numbers can include {−20, −15, −10, −5, 0, 2, 4, 8}.

The optimization problem is defined in Equation 3 below, where the goal is to allocate the token adaptation number γ to the respective batches that maximizes the overall utility for all queries in all batches in the batch queue B.

$${max}_{γ b} {\sum }_{b ∈ [ 1 , {N}_{B} ]} {\sum }_{r ∈ {B}_{b}} {u}_{r} \cdot {α}_{r} ; \qquad Equation 3$$

$${s}_{r} + {t}_{r}^{( q )} + {t}_{r}^{( p )} < {d}_{r} , ∀ r ∈ {B}_{b} ; \qquad Constraint 3 a$$

$${s}_{r} + {t}_{r}^{( q )} + {t}_{r}^{( p )} {s}_{{r}^{′}} + {t}_{{r}^{′}}^{( q )} , ∀ r ∈ {B}_{b} and ∀ {r}^{′} ∈ {B}_{b + 1} ; and \qquad Constraint 3 b$$

$${M}_{b} < {M}_{GPU} . \qquad Constraint 3 c$$

In this regard, Equation 3 is based on the assumption that if the transformer model 122 successfully provides an accurate result for a query r under the latency requirement for the query, the computing system 100 can be rewarded with utility uᵣ, such as reward point, a monetary reward or another form of a reward, as weighted by the utility value associated with the query. The notation αr∈{0, 1} can be used to represent whether the transformer model 122 successfully serves a query r as executed by the computing system 100. The required memory of batch b and the available memory (e.g., of memory 142) to the processing unit (e.g., processing unit 144) are denoted as M_{b} and M_{GPU} respectively. Constraint (3a) ensures that all requests can be completed within their respective completion deadlines, where t(q) r and t(p) r are the queuing time and processing time. Constraint (3b) ensures that the batches in the batch queue are executed sequentially (in accordance with their time ordered arrangement). Constraint (3c) imposes a memory restriction, as larger batch sizes and prompt numbers can increase the memory demand.

Equation 3 considers both the query load and request characteristics. If the batch queue has a high volume of queries, the token settings component 116 should pick a smaller γ to reduce the queuing and processing time and serve more requests. Conversely, the token settings component 116 can increase the value of γ to derive a more accurate inference result and earn more utilities.

In some implementations, Equation 3 can be considered a nondeterministic polynomial time hard problem (i.e., an NP-hard problem) because it can be reduced to another NP-hard problem known as a Weighted Interval Scheduling Problem (WISP). To this end, given a set of intervals with a weight, the objective of WISP is to select some intervals that can maximize the sum of the weights while the selected intervals are pairwise disjoint. Thus, Equation 3 can be considered a WISP. To this end, each batch can be considered as an interval with a weight equal to its utility, with the goal being to efficiently process the batches in the queue so that the sum of utilities is maximized. However, Equation 3 is more difficult than a WISP because the token settings component 116 also needs to adjust the running time for the picked intervals with different γ values.

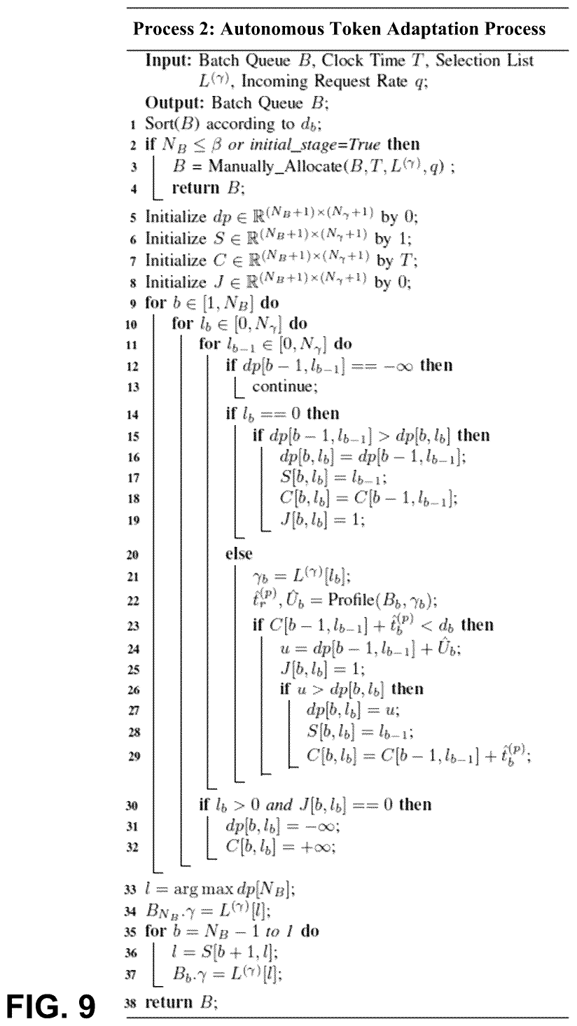

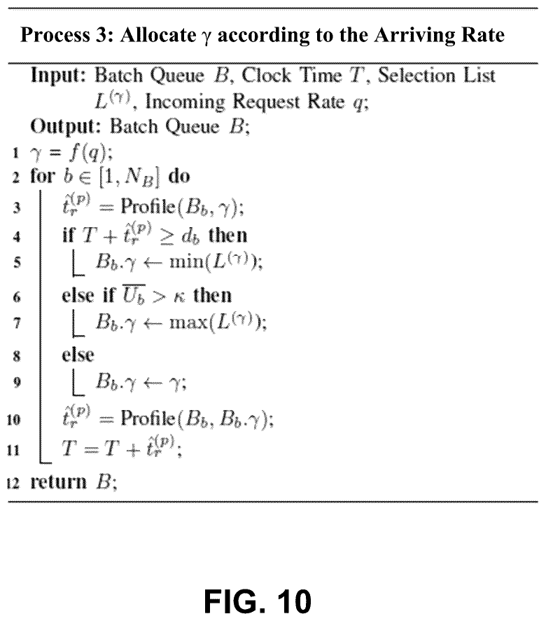

Due to the NP-hardness of Equation 3, in some implementations, the token settings component 116 can employ an efficient dynamic programming process to derive the solution. This dynamic programming process formulates Equation 3 in accordance with Process 2. Process 2 is illustrated in FIG. 9. In some implementations in which the computing system 100 initially begins serving queries, the number of batches in the batch queue ready for execution may less than a threshold number that renders Process 2 appropriate for determining the token adaptation numbers for the batches. In these scenarios, the token settings component 116 can be configured to employ a less complicated process, referred to herein as Process 3, to allocate the token adaptation numbers. Process 3 is illustrated in FIG. 10.

With reference to FIGS. 9 and 10 in view of FIGS. 1-8, Process 2 and Process 3 respectively takes the batch queue B, current time T, the pre-defined available γ list L^{(γ)} and the estimated incoming request rate q as inputs and output the updated batch queue with allocated token adaptation number γ for each batch in the batch queue. In various embodiments, the performance profiling component 118 can calculate the incoming request rate q based on a sampled request rate for a previous window of time prior to the current time T. In accordance with using Process 2 and Process 3 to determine the token adaptation numbers γ for respective batches in the batch queue at 706 of process 700, the token settings component 116 begins by sorting the batches according to their required deadlines.

With reference to Process 3, if the size of the batch queue B is less than a threshold β or the computing system 100 has just initially begun to accept queries 102 and thus is in an initial serving stage, then the token settings component 116 can be configured to determine the token adaptation numbers for the respective batches based on the query load with Process 3. This is because the dynamic programming process works well when there are sufficient batches to make a long-term schedule, which does not yet exist in the initial serving stage. Process 3 allocates the token number γ by comparing the incoming request rate q and the throughput of different γ values. The tokens settings component 116 can further apply a projection function ƒ to map q to a suitable value of γ (Line 1). In this regard, the task profiling component 126 can profile ƒ offline according to the throughput of different γ values in association with performing the task specific profiling at 604 of process 600. Then, the token settings component 116 can adjust the selection of γ according to the query characteristics in accordance with the task profiling data 134. The performance profiling component 118 can predict the execution time for a batch b based on the task profiling data 134 and respective query tasks of the queries included in the batch (and their corresponding latency constraints). If the estimated completion time exceeds the deadline, the token settings component 116 can set the token number as the minimum value to meet the latency constraints (Lines 3˜5). If the average utility U̅_̅{̅b̅}̅ is larger than a threshold κ, the token settings component 116 can set the token adaptation number γ as the maximum value to prioritize the critical queries. Finally, the performance profiling component 118 estimates the execution time and updates the current time T.

With reference to Process 2, on the other hand, if the size of the batch queue 138 is greater than threshold B, then the token settings component 116 can be configured to determine the token adaptation numbers for the respective batches using Process 2. Process 2 corresponds to an autonomous token adaptation algorithm. The key idea of Process 2 is to find the largest utility value for a batch b with a γ_{b} through iterative traversal.

Process 2 utilizes four auxiliary arrays of size (N_{B}+1)×(N_{γ}+1) to implement dynamic programming, where N_{B} and N_{γ} are the sizes of the batch queue and the number of available γ values respectively. Specifically, dp records the accumulated utilities, S records the previous γ selection scheme, and C records the clock time after executing batch b with γ. The array J indicates whether executing b with γ satisfies the deadline requirement. For each batch in the batch queue, the token settings component 116 iteratively assigns a value of γ from the list L^{(γ)} to batch b using the index l_{b} (Lines 9˜11). If batch b−1 cannot be executed with γ indexed with l_{b}−1, the token settings component 116 continue to the next iteration of the loop (Lines 12˜13). When the value of l_{b} is 0, it indicates that batch b is not executed, and the tokens settings component 116 directly finds a larger utility value from batch b−1 and assign it to batch b (Lines 14˜19).

When executing γ_{b} for batch b, the performance profiling component 118 first estimates the inference time and utility through profiling (Line 22) using the task profiling data 134. If the inference time is smaller than the required deadline, the task settings component 116 calculates the overall utility and sets the execution plan as 1 (Lines 23˜25). If the utility is larger than the previous values, the task settings component 116 updates the matrixes. If there is no feasible execution plan for batch b with γ_{b}, the task settings component 116 sets the dp value as −∞ and the clock time as +∞ (Lines 30˜32).

Once the task settings component 116 has calculated the utility values and their corresponding choices, the task settings component 116 can derive the solution to Process 2 by backtracking. In this regard, the task settings component 116 first determines the value of γ for the N_{B-th} batch based on the highest dp value. For each batch, the task settings component 116 obtains the index of γ according to the value of S[b+1, γ]. Finally, the task settings component return the updated batch queue B with the token adaptation numbers γ determined for each batch in the batch queue.

In accordance with Process 2 and Process 3, the performance profiling component 118 (or the task settings component 116) estimates the execution time and utility for a batch b with the task profiling data 134. For example, as described with reference to FIG. 6 and process 600, prior to online serving of the transformer model 122, the task profiler component 126 profiles the accuracy and sample-level (i.e., task specific and input data content specific) inference latency for all tasks and store them in the task profiling data 134.

To estimate the inference time for the current batch during online serving, the performance profiling component 118 (or the task settings component 116) first counts the number of samples for each task, and then multiplies the sample number by the corresponding profiling inference time to obtain the execution time for that task. The performance profiling component 118 (or the task settings component 116) then sums up the calculation results for all tasks to obtain the predicted inference time of a batch. To calculate the overall utility, the performance profiling component 118 (or the task settings component 116) computes the product of the accuracy with a selected γ and the utility of each query in the batch. The performance profiling component 118 (or the task settings component 116) Then, the product results of all queries are summed up to obtain the total utility of a batch. During profiling, the performance profiling component 118 (or the task settings component 116) ensures that all the running processes adhere to the memory constraints of Eq. (3c) and the computing system 100.

With reference again to FIG. 7 and process 700, once the task settings component 116 has determined the respective token execution settings at 706 process 700 continues to 709. In this regard, in accordance with using Process 2 and/or Process 3, the token execution settings correspond to the respective token adaptation numbers γ for the respective batches. In other embodiments, the token execution settings can include or correspond token adaptation settings tailored for each batch that incorporate a combination of token prompting and token merging, with respective numbers of tokens to be added and removed via the corresponding processes. At 709, the execution component 120 then sequentially applies the transformer model 122 to the batches in the batch queue in association with directing the transformer model 122 to employ the corresponding token execution settings for the respective batches to generate inference results for the queries.

In this regard, as described with reference to FIG. 2 the transformer model 122 is configured to perform token prompting (e.g., token prompting process 212) and/or token merging (e.g., token merging process 212) in accordance with the assigned token execution settings for the respective batches in association with processing the respective batches to generate the inferenced results 106 for respective request queries included in the respective batches. For example, in various embodiments, to facilitate this end, in association with supplying a batch to the transformer model 122, the execution component 120 can instruct the transformer model regarding the applicable token execution settings and the transformer model 122 can be configured to apply them. In this regard, at 709, in association applying the transformer model 122 to a batch, the execution component 120 can forward the batch of input data samples for the batch to the transformer model 122 and include information with the batch that identifies the γ value the corresponding tasks of the respective data samples (e.g., via respective task IDs).

Based on the token adaptation number γ being a positive number, the transformer model 122 can be configured to perform the token prompting process 212 and add/concatenate the corresponding number of prompt tokens represented by the γ to the initial execution tokens for the input data samples. For example, a token adaptation number of γ=2 directs the transformer model 122 to add (e.g., via prompting layer 210 and prompting process 212) 2 prompting tokens to the initial tokens (e.g., generated at tokenization) for respective input data samples of a batch, a token adaptation number of γ=4 directs the transformer model 122 to add 4 prompting tokens to the initial tokens for respective input data samples of a batch, and so on. In association with adding prompting tokens, the prompting layer 210 is configured to select task specific prompting tokens for each query included in the batch as provided in the prompt repository data 136. In this regard, using the task IDs for the respective data samples, the prompting layer 210 can extract the one or more prompt tokens and/or prompt parameter defined for the respective task IDs from the prompt repository data 136. In accordance with token prompting, if the batch size is n_{b} and the input token length is nᵢ, the token shape becomes n_{b}×(nᵢ+γ) after prompting via the prompting layer 210. The added prompting tokens can inspire the multi-head attention to generate a better (i.e., more accurate) result.

Based on the token adaptation number γ being a negative number, the transformer model 122 can be configured to perform the token merging process 228 via merging layer 226 to reduce the number of initial execution tokens by corresponding number γ. For example, token adaptation number of γ=−20 directs the transformer model 122 to remove (e.g., via merging layer 226 and merging process 228) 20 of the initial tokens (e.g., generated at tokenization) for respective input data samples of a batch, a token adaptation number of γ=−15 directs the transformer model 122 to remove 15 of the initial tokens, and so on. In accordance with the token merging process 228, the transformer model 122 directly processes the input tokens. Given the token similarity obtained from multi-head attention and a defined merging rule 230 (e.g., the merging rule 230 corresponding to process 500 or the like), the merging layer 226 can reduce the token shape from n_{b}×nᵢ to n_{b}×(nᵢ−|γ|).

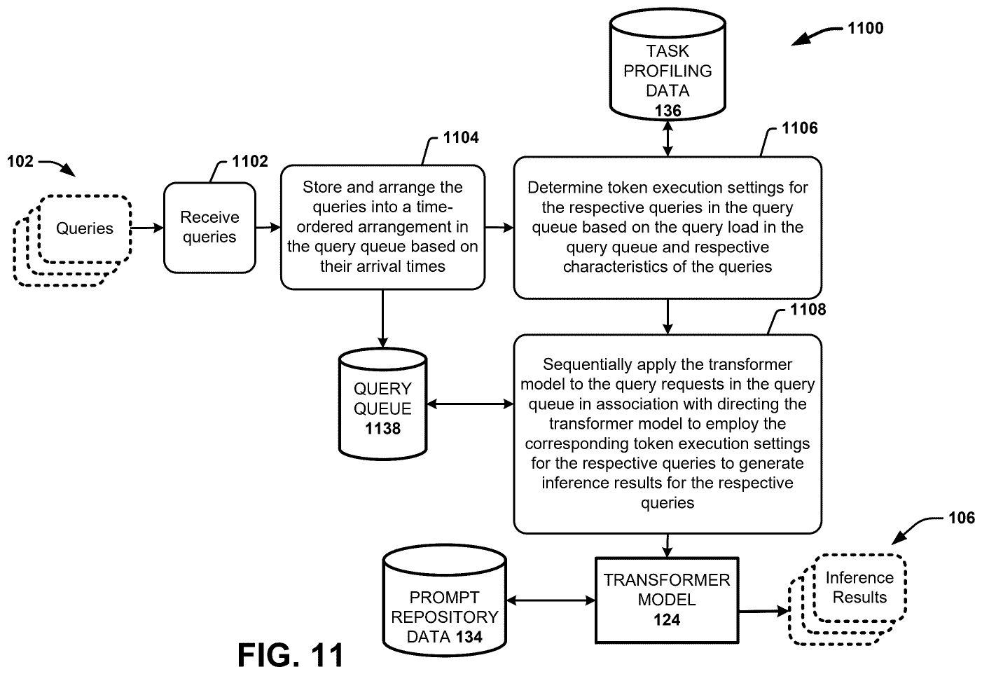

FIG. 11 illustrates another example elastic transformer serving process 1100 via token adaptation, in accordance with one or more embodiments of the disclosed subject matter. Process 1100 is similar to process 700 yet simplified as tailored to processing individual queries as opposed to batch processing. In this regard, it should be appreciated that the disclosed token adaptation techniques can be extended to improve inference accuracy and inferencing speed in other serving scenarios in which individual queries are processed by a computing system (e.g., corresponding to computing system 100) with lightweight memory and processing hardware and serving demands.

In this regard, in accordance with process 1100, at 1102, the computing system received queries 102 (e.g., via reception component 110). At 1104, the scheduling component 114 can store and arrange the queries into a time-ordered arrangement in a query queue 1138 based on their arrival times. At 1106, the tokens settings component 116 can determine token execution settings for the queries in the query queue 1138 based on the query load in the query queue 1138 and respective characteristics of the queries. For example, similar to the mechanism employed for batches, the token settings component 116 can determine a token adaptation number γ for each query in the query queue based on respective latency requirements of the queries, respective task types, respective utilities, respective input data sample content, respective arrival times, respective completion deadlines and so on, in a manner that optimizes the overall utilities of the query queue while satisfying or exceeding (e.g., meaning processing even faster than required) their respective latency constraints. At 1108, the execution component 120 can sequentially apply the transformer model 122 to the queries in the query queue 1138 in association with directing the transformer model 122 to employ the corresponding token execution settings for the respective queries to generate inference results 106 for the respective queries.

With reference to FIGS. 1-11, in various embodiments, the techniques afforded by computing system 100, process 600, process 700 and/or process 100 can be generalized can be generalized to language and multi-modal tasks, various transformer models, different execution environments and different prompt learning mechanisms and token reduction processes. In this regard, the disclosed techniques can be summarized as follows: simplicity. (1) Choose a pre-trained transformer model as the foundation model. (2) Investigate the prompt learning method for the pre-trained model and train the prompt pool. (3) Design the token reduction process and build a unified transformer model that is flexible in adding and removing tokens. (4) Profile the accuracy and inference latency for different γ values, batch sizes and sequence lengths. (5) Based on the profiling results, determine the γ list for online adaptation. (6) Apply the profiling data to Process 2 for adaptively selecting a γ value for respective batches and/or individual queries during the online serving period.

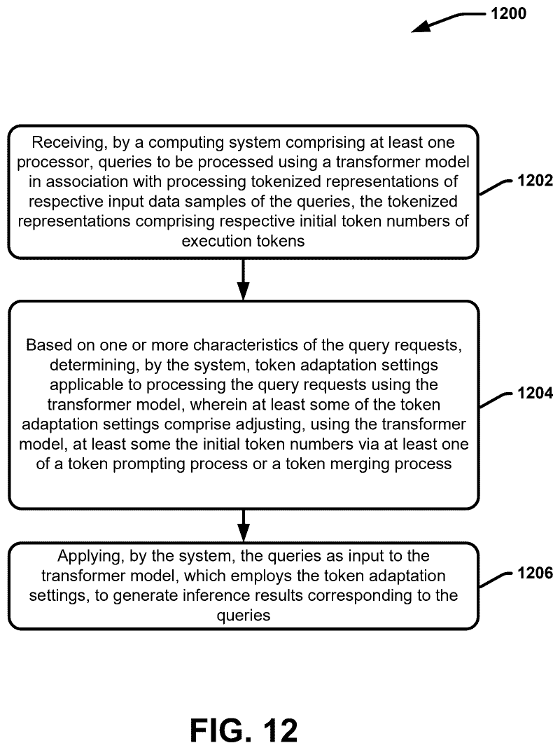

FIG. 12 illustrates an example computer-implemented method 1200 for performing elastic transformer serving, in accordance with one or more embodiments of the disclosed subject matter. Method 1200 comprises, at 1202, receiving, by a computing system comprising at least one processor (e.g., computing system 100), queries (e.g., queries 102) to be processed using a transformer model (e.g., transformer model 122) in association with processing tokenized representations of respective input data samples of the queries, the tokenized representations comprising respective initial token numbers of execution tokens (e.g., generated via tokenization). At 1204, method 1200 comprises, based on one or more characteristics of the queries (e.g., input data sample content, task types, latency constraints, utilities, arrival times, etc.), determining, by the system (e.g., via token settings component 116 and performance profiler component 118), token adaptation settings applicable to processing the queries using the transformer model, wherein at least some of the token adaptation settings comprise adjusting, using the transformer model, at least some the initial token numbers via at least one of a token prompting process or a token merging process. At 1206, method 1200 comprises applying, by the system, the queries as input to the transformer model (e.g., via execution component 120), which employs the token adaptation settings, to generate inference results (e.g., inference results 106) corresponding to the queries.

In this regard, in accordance with method 1200, the adjusting of the at least some of the initial token numbers using the transformer model via the token prompting process results in increasing an accuracy level of the inference results, and wherein the adjusting of the at least some the initial token numbers using the transformer model via the token merging process results in decreasing a latency level of the transformer model in association with the processing of the queries.

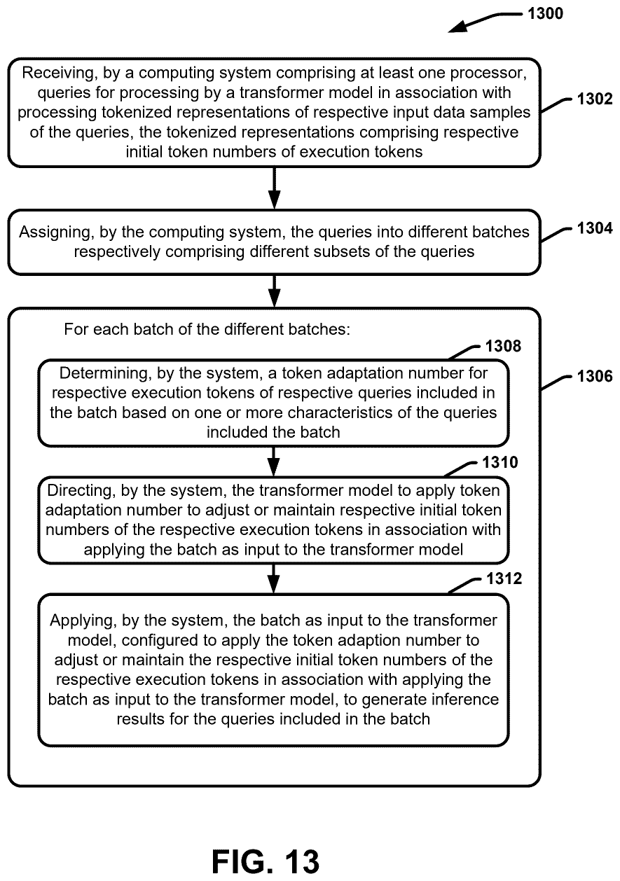

FIG. 13 illustrates another example computer-implemented method 1300 for performing elastic transformer serving, in accordance with one or more embodiments of the disclosed subject matter. Method 1300 comprise, at 1302, receiving, by a computing system comprising at least one processor (e.g., computing system 100), queries for processing by a transformer model (e.g., transformer model 122) in association with processing tokenized representations of respective input data samples of the queries, the tokenized representations comprising respective initial token numbers of execution tokens. At 1304, method 1300 comprises assigning, by the computing system, the queries into different batches respectively comprising different subsets of the queries (e.g., via scheduling component 114). Method 1300 further includes sub-process 1306 which is performed by the computing system 100 for each for each batch of the different batches. In this regard, sub-process 1300 comprises at 1308 determining, by the system, a token adaptation number for respective execution tokens of respective queries included in the batch based on one or more characteristics of the queries included the batch (e.g., via token settings component 116). At 1310, directing, by the system, the transformer model to apply token adaptation number to adjust (e.g., increase via adding one or more prompt tokens and/or decrease via removing one or more of the execution tokens) or maintain respective initial token numbers of the respective execution tokens in association with applying the batch as input to the transformer model (e.g., via execution component 120). At 1312, method 1300 comprises applying, by the system, the batch as input to the transformer model, configured to apply the token adaption number to adjust or maintain the respective initial token numbers of the respective execution tokens in association with applying the batch as input to the transformer model, to generate inference results for the queries included in the batch (e.g., via execution component 120).

In accordance with method 1300, based on the token adaptation number being greater than a threshold number (e.g., zero), the transformer model, configured according to the token adaptation number, adds one or more prompt tokens to the respective execution tokens. Based on the token adaptation number being less than the threshold number, the transformer model, configured according to the token adaptation number, reduces the respective initial token numbers using a token merging process. Based on the token adaptation number being equal to the threshold number, the transformer model, configured according to the token adaptation number, maintains the respective initial token numbers.

### Experimental Implementation of OTAS

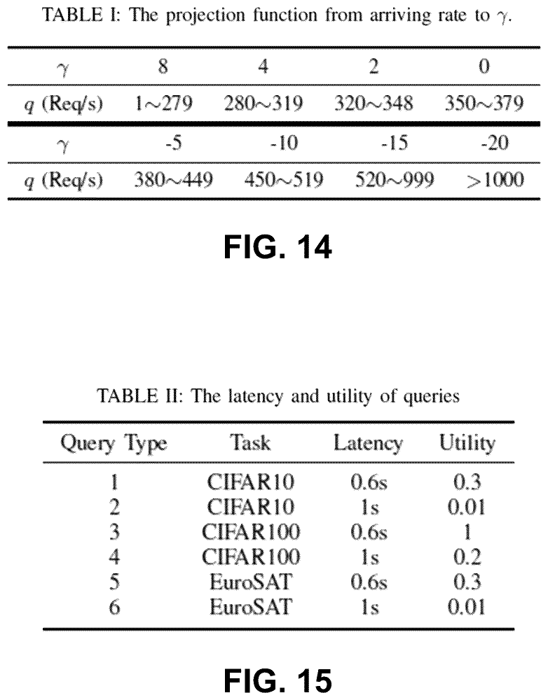

A prototype of OTAS can be implemented (e.g., computing system 100) in accordance with process 700 and FIG. 7 that supports dynamically allocating the token number for a batch and running the transformer model in flexible way. The results show that OTAS can improve the utility by at least 18.2% on both simulated and real-world production traces from Azure compared with other state-of-the-art methods. The observed performance improvement is achieved because OTAS can identify an optimal balance between the overhead of token increment and the benefits of accuracy improvement based on the real-time query load and user demands. The implementation prototype of OTAS, the experiment, and the results are presented below with reference to FIGS. 14-21B.

### I. Implementation

OTAS Implementation Description. Four data structures and corresponding interfaces can be provided to implement the OTAS prototype. TransformerModel is a transformer model class that comprises token prompting and token reduction modules. This model is loaded with pre-trained weights. TaskModel stores all parameters for a task, such as the prompts and classification head. ServeModel serves as the base model for the frontend surface. Its forward method accepts a batch of inputs, the corresponding input tasks, the parameter list of TaskModel and the γ value as input and returns the inference result. The Batch class is responsible for adding a query to the batch, providing profiling results and returning a batch of queries within latency constraints for inference.

Implementation Tools. The OTAS prototype can be implemented based on the PetS. Python can be used, for example, to process the incoming queries and implement the batching and token adaptation processes. PyTorch can be used, for example, to define the neural networks, including TransformerModel, TaskModel and ServeModel. The transformer model can be built with a timm library and two modules can be inserted to add and remove the processing tokens at each layer. The prompt learning and token reduction processes can be implemented, for example, according to VPT and ToMe.

User Interface. The system enables users to make a query and register tasks with two interfaces. The Make Query interface processes a query that comprises an image sample and various attributes, such as the task ID, latency requirement and utility. Then, the query can be assigned to a batch with Process 1. The Register Task interface saves the task parameters in the task model list and the corresponding latency and utility values in the task data list.

### II. Experiment

Setup. The ViT-Base model can be used, which can be pre-trained on ImageNet 21K as the foundation model, which contains 12 transformer layers. The head number of attention is 12, and the feature dimension is 768. The patch size of the images is 16×16. Three datasets can be used, including CIFAR10, CIFAR100 and EuroSAT, and ⅕ of the training data was randomly selected as the profiling set. The γ selection list can be defined as {−20, −15, −10, −5, 0, 2, 4, 8} and it can be adjusted according to the query rate. The values of δ, ε, η and μ in Process 1 are set as 0.5 s, 64, 0.5 s and 0.8 respectively. The value of β can be set as 5 and the initial stage can be defined as the first 2 seconds of the service. The value of κ in Process 3 is 0.8 and the projection function ƒ is defined in Table I illustrated in FIG. 14. The prompts are trained for tasks offline. The training batch size, epochs and learning rate are set as 32, 50 and 0.002. OTAS can be evaluated, for example, on an NVIDIA Geforce RTX 4080 (12th Gen Intel® Core™ i9-12900K CPU) machine.

Baseline. OTAS can be compared with PetS and INFaaS. PetS is a unified framework for serving transformers with parameter-efficient methods and optimizes task-specific and task-shared operators. PetS remains token unchanged and inference is performed with a shared foundation model and task-specific heads. INFaaS is a model adaptation method that selects an appropriate model according to the query load. The candidate model list is set as ViT-Small, ViT-Base and ViT-Large. OTAS can also be compared with ToMe and VPT that uses fixed merging or prompting number.

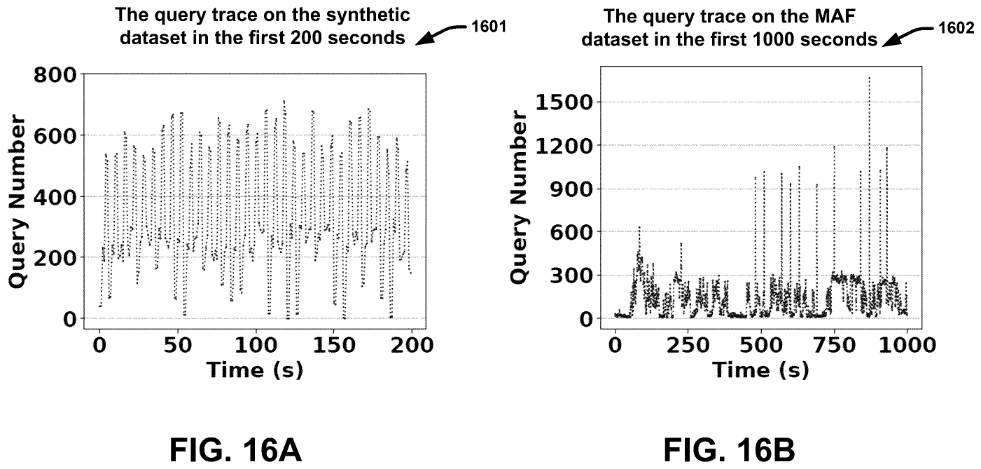

Workloads. Processes can be evaluated using both synthetic query trace and real-world production trace. For synthetic workloads, the query traces are generated that have fluctuating loads. The arrival time is randomly generated for queries according to the Poisson distribution. Table II illustrated in FIG. 15 provides six different query types used and the latency constraints and utility values of the respective query types. A query type is randomly selected from Table II for each query. Based on experiments over a 30-minute serving period, with more than 63 k queries processed, FIG. 16A presents the query number per second during the first 200 seconds. The query rate varies between 200 requests per second (Req/s) to 700 Req/s.

For real-world workloads, the publicly-released traces of Microsoft collected from Azure Functions in 2021 (MAF), for example, can be used. A 120-hour trace can be used, for example, for experiments. Requests collected every two-minute interval can be aggregated into one-second interval to create a challenging trace. The query number per second in the first 1000 seconds is presented in FIG. 16B. During more than 60% of the serving period, the query rate remains below 300 Req/s. There are still some instances where the request number per second exceeds 600 Req/s.

### III. Results

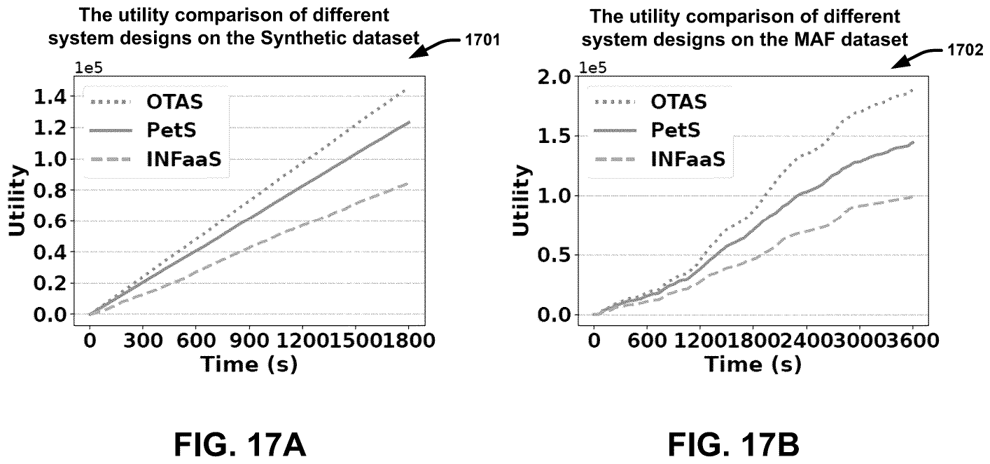

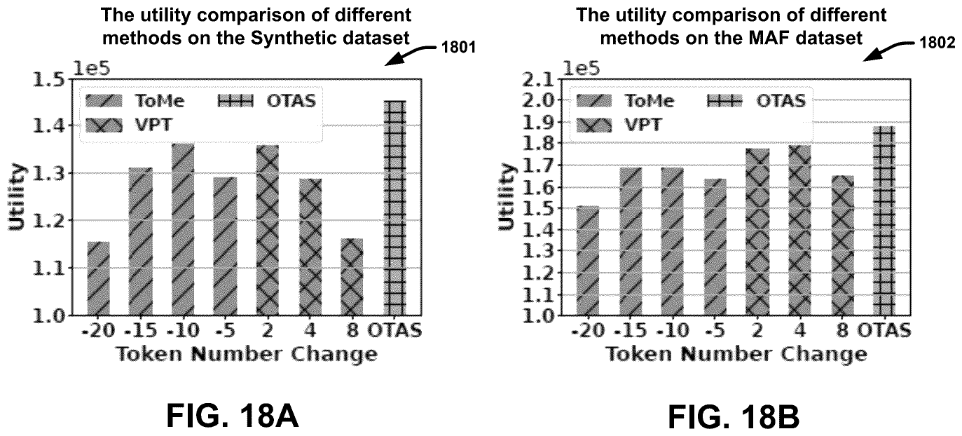

The overall utility. If the system can return an accurate result for a query under the latency constraint, it can be rewarded the utility of the query. The accumulated utilities of three system designs on the synthetic dataset are shown in FIG. 17A. OTAS obtains about 1.46×105 utilities and results in a utility improvement of 18.2% and 72.5%. INFaaS behaves the worst because it has a long I/O latency to switch the models. The overall utility of the MAF dataset is shown in FIG. 17B. OTAS can improve the utility by up to 90.1%. The utility comparison of the different methods on the synthetic dataset with fixed token numbers is shown in FIG. 18A. The utility comparison of the different methods on the MAF dataset with fixed token numbers is shown in FIG. 18B. OTAS outperforms both ToMe and VPT because it can adjust the token strategy according to the query load.

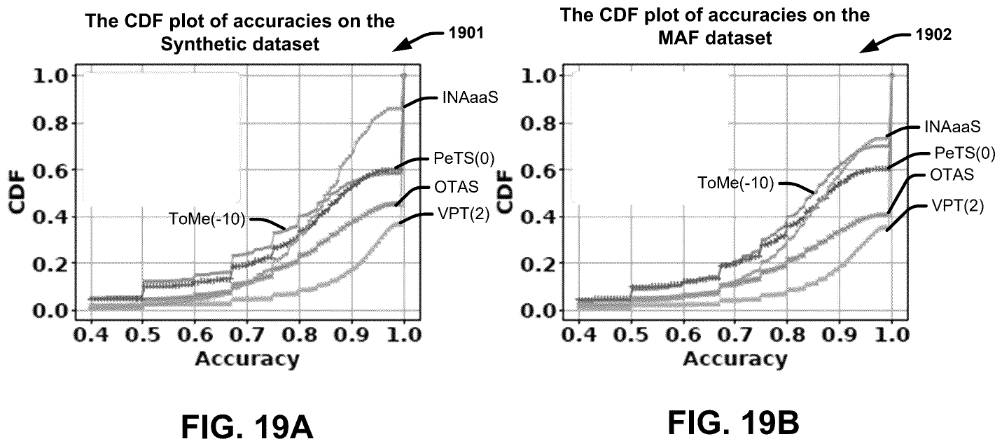

The accuracies of batches. The CDF plot of accuracies is presented for served batches with five methods on the synthetic dataset in FIG. 19A, and a higher accuracy value typically indicates a more effective process. The VPT method with a prompting number of 2 achieves the highest accuracy because of the incorporation of well-trained prompting tokens. The ToMe method exhibits relatively low accuracy, owing to the reduction of tokens. OTAS can select an appropriate execution scheme dynamically, thereby achieving a balance between accuracy and latency. The average accuracy of our method is larger than 90%, indicating that our approach can successfully provide accurate results for served queries.

As shown in FIG. 19B, the batch accuracy on the MAF dataset is similar to that observed on the synthetic dataset. The accuracy curve exhibits a sudden increase as it approaches 1, primarily due to the large number of batches with a perfect accuracy score of 1.

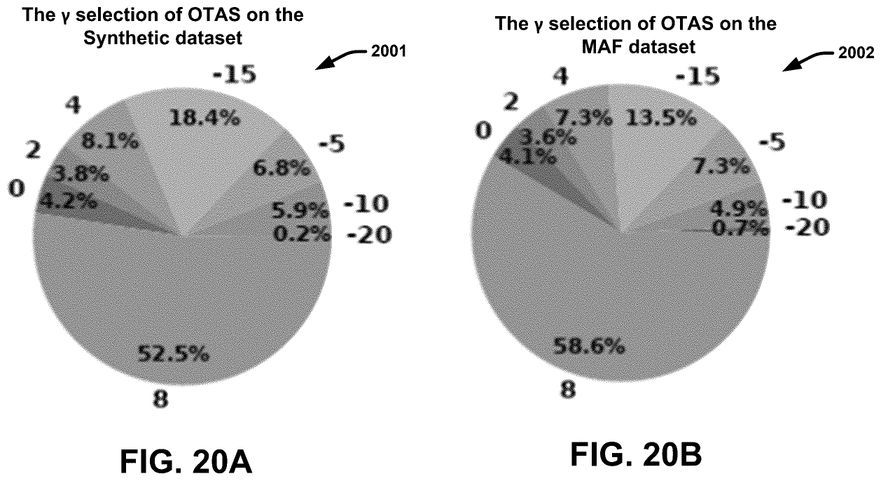

The γ selection. OTAS can change the token number γ according to the incoming load and the query characteristics. The γ selection ratio of OTAS on the synthetic dataset is presented in FIG. 20A and the MAF dataset is presented in FIG. 20B. On the synthetic trace, OTAS selects γ=8 at most, given the flat request load for most of the serving period. Another major selection is γ=−15 because it can reduce the inference time while keeping the accuracy nearly unchanged. On the MAF trace, more batches were executed with a prompting number of 8 because of the light query loads. During busy periods, OTAS selects a γ value of −15 to serve more queries.

The execution type of a query. Queries have different processing outcomes, which can be classified into the following categories. Type 1—obtaining accurate results and meeting latency constraints; Type 2—obtaining incorrect results while still meeting latency constraints; Type 3—obtaining inference results while unable to meet latency deadlines; and Type 4—queries that cannot meet latency constraints before actual execution and have been evicted.

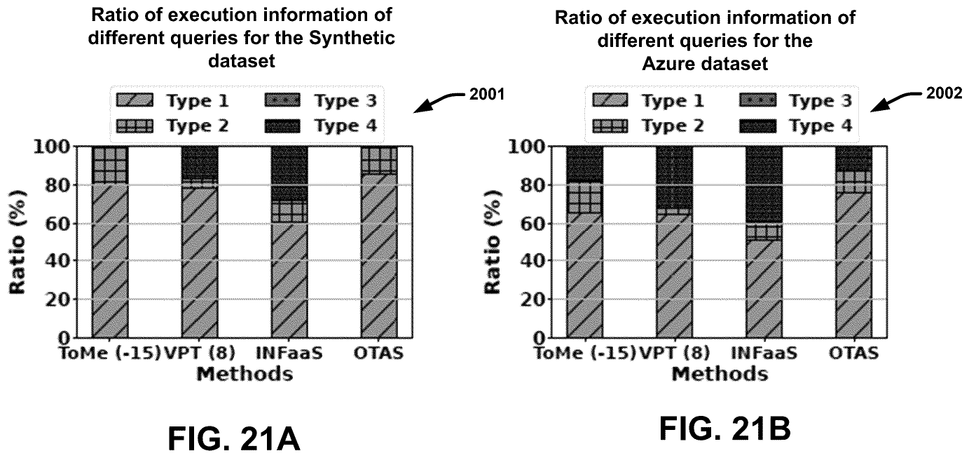

The execution ratio of different query types on the synthetic dataset is visualized in FIG. 21A. It can be observed that OTAS is able to successfully serve 85.54% of the queries (Type 1), and all queries can meet the latency requirement. On the other hand, ToMe can serve fewer queries because it has a low prediction accuracy. VPT and INFaaS has a longer inference time that leads to a higher eviction ratio. Therefore, our method can achieve an excellent trade-off between accuracy and latency that leads to a higher serving rate.

The execution ratio of different query types on the MAF dataset is presented in FIG. 21B. Because there are some highly bursty loads in the MAF dataset, the ratio of evicted queries (Type 4) increases due to the limited computational resources. Compared to other methods, OTAS serves the highest number of requests, with a success rate of 75.58%. For the ToME method, 16.85% of requests are mispredicted, which still consume computational resources. The success ratio of VPT is only 64.14% due to the high inference latency caused by token prompting. As a result, 32.16% of requests cannot meet the designated deadline and are evicted. Our method is more flexible to deal with the bursty query loads.

### Example Operating Environments

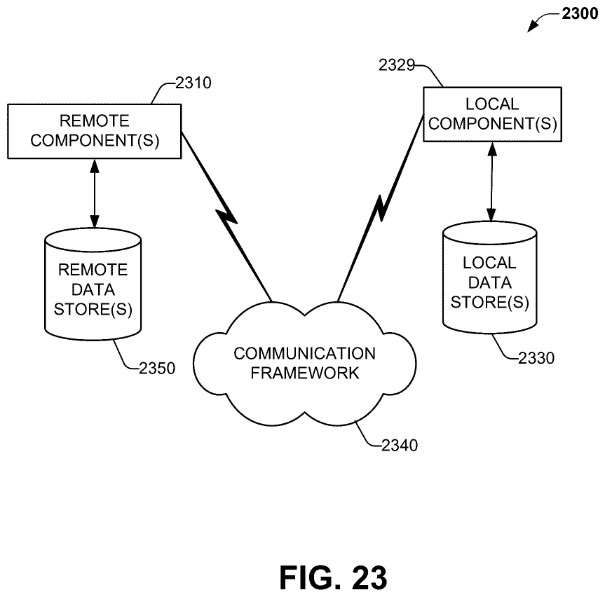

One or more embodiments can be a system, a method, and/or a computer program product at any possible technical detail level of integration. The computer program product can include a computer readable storage medium (or media) having computer readable program instructions thereon for causing a processor to carry out aspects of the present invention. Turning next to FIGS. 22 and 23, a detailed description is provided of additional context for the one or more embodiments described herein with FIGS. 1-13.

In order to provide additional context for various embodiments described herein, FIG. 22 and the following discussion are intended to provide a brief, general description of a suitable computing environment 2200 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 22, the example environment 2200 for implementing various embodiments of the aspects described herein includes a computer 2202, the computer 2202 including a processing unit 2204, a system memory 2206 and a system bus 2208. The system bus 2208 couples system components including, but not limited to, the system memory 2206 to the processing unit 2204. The processing unit 2204 can be any of various commercially available processors and may include a cache memory. Dual microprocessors and other multi-processor architectures can also be employed as the processing unit 2204.

The system bus 2208 can be any of several types of bus structure that can further interconnect to a memory bus (with or without a memory controller), a peripheral bus, and a local bus using any of a variety of commercially available bus architectures. The system memory 2206 includes ROM 2210 and RAM 2212. A basic input/output system (BIOS) can be stored in a non-volatile memory such as ROM, erasable programmable read only memory (EPROM), EEPROM, which BIOS contains the basic routines that help to transfer information between elements within the computer 2202, such as during startup. The RAM 2212 can also include a high-speed RAM such as static RAM for caching data.

The computer 2202 further includes an internal hard disk drive (HDD) 2214 (e.g., EIDE, SATA), one or more external storage devices 2216 (e.g., a magnetic floppy disk drive (FDD) 2216, a memory stick or flash drive reader, a memory card reader, etc.) and an optical disk drive 2220 (e.g., which can read or write from a CD-ROM disc, a DVD, a BD, etc.). While the internal HDD 2214 is illustrated as located within the computer 2202, the internal HDD 2214 can also be configured for external use in a suitable chassis (not shown). Additionally, while not shown in environment 2200, a solid-state drive (SSD) could be used in addition to, or in place of, an HDD 2214. The HDD 2214, external storage device(s) 2216 and optical disk drive 2222 can be connected to the system bus 2208 by an HDD interface 2224, an external storage interface 2226 and an optical drive interface 2228, respectively. The interface 2224 for external drive implementations can include at least one or both of Universal Serial Bus (USB) and Institute of Electrical and Electronics Engineers (IEEE) 10224 interface technologies. Other external drive connection technologies are within contemplation of the embodiments described herein.

The drives and their associated computer-readable storage media provide nonvolatile storage of data, data structures, computer-executable instructions, and so forth. For the computer 2202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2212, including an operating system 2230, one or more application programs 2232, other program modules 2234 and program data 2236. All or portions of the operating system, applications, modules, and/or data can also be cached in the RAM 2212. The systems and methods described herein can be implemented utilizing various commercially available operating systems or combinations of operating systems.

Computer 2202 can optionally comprise emulation technologies. For example, a hypervisor (not shown) or other intermediary can emulate a hardware environment for operating system 2230, and the emulated hardware can optionally be different from the hardware illustrated in FIG. 22. In such an embodiment, operating system 2230 can comprise one virtual machine (VM) of multiple VMs hosted at computer 2202. Furthermore, operating system 2230 can provide runtime environments, such as the Java runtime environment or the .NET framework, for applications 2232. Runtime environments are consistent execution environments that allow applications 2232 to run on any operating system that includes the runtime environment. Similarly, operating system 2230 can support containers, and applications 2232 can be in the form of containers, which are lightweight, standalone, executable packages of software that include, e.g., code, runtime, system tools, system libraries and settings for an application.

Further, computer 2202 can comprise a security module, such as a trusted processing module (TPM). For instance with a TPM, boot components hash next in time boot components, and wait for a match of results to secured values, before loading a next boot component. This process can take place at any layer in the code execution stack of computer 2202, e.g., applied at the application execution level or at the operating system (OS) kernel level, thereby enabling security at any level of code execution.

A user can enter commands and information into the computer 2202 through one or more wired/wireless input devices, e.g., a keyboard 2238, a touch screen 2240, and a pointing device, such as a mouse 2242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2204 through an input device interface 2244 that can be coupled to the system bus 2208, but can be connected by other interfaces, such as a parallel port, an IEEE 10224 serial port, a game port, a USB port, an IR interface, a BLUETOOTH® interface, etc.

A monitor 2246 or other type of display device can be also connected to the system bus 2208 via an interface, such as a video adapter 2248. In addition to the monitor 2246, a computer typically includes other peripheral output devices (not shown), such as speakers, printers, etc.

The computer 2202 can operate in a networked environment using logical connections via wired and/or wireless communications to one or more remote computers, such as a remote computer(s) 2250. The remote computer(s) 2250 can be a workstation, a server computer, a router, a personal computer, portable computer, microprocessor-based entertainment appliance, a peer device or other common network node, and typically includes many or all of the elements described relative to the computer 2202, although, for purposes of brevity, only a memory/storage device 2252 is illustrated. The logical connections depicted include wired/wireless connectivity to a local area network (LAN) 2254 and/or larger networks, e.g., a wide area network (WAN) 2256. Such LAN and WAN networking environments are commonplace in offices and companies, and facilitate enterprise-wide computer networks, such as intranets, all of which can connect to a global communications network, e.g., the internet.

When used in a LAN networking environment, the computer 2202 can be connected to the local network 2254 through a wired and/or wireless communication network interface or adapter 2258. The adapter 2258 can facilitate wired or wireless communication to the LAN 2254, which can also include a wireless access point (AP) disposed thereon for communicating with the adapter 2258 in a wireless mode.

When used in a WAN networking environment, the computer 2202 can include a modem 2260 or can be connected to a communications server on the WAN 2256 via other means for establishing communications over the WAN 2256, such as by way of the internet. The modem 2260, which can be internal or external and a wired or wireless device, can be connected to the system bus 2208 via the input device interface 2244. In a networked environment, program modules depicted relative to the computer 2202 or portions thereof, can be stored in the remote memory/storage device 2252. It will be appreciated that the network connections shown are example and other means of establishing a communications link between the computers can be used.

When used in either a LAN or WAN networking environment, the computer 2202 can access cloud storage systems or other network-based storage systems in addition to, or in place of, external storage devices 2216 as described above. Generally, a connection between the computer 2202 and a cloud storage system can be established over a LAN 2254 or WAN 2256 e.g., by the adapter 2258 or modem 2260, respectively. Upon connecting the computer 2202 to an associated cloud storage system, the external storage interface 2226 can, with the aid of the adapter 2258 and/or modem 2260, manage storage provided by the cloud storage system as it would other types of external storage. For instance, the external storage interface 2226 can be configured to provide access to cloud storage sources as if those sources were physically connected to the computer 2202.

The computer 2202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 23, an illustrative cloud computing environment 2300 is depicted. FIG. 23 is a schematic block diagram of a computing environment 2300 with which the disclosed subject matter can interact. The system 2300 comprises one or more remote component(s) 2310. The remote component(s) 2310 can be hardware and/or software (e.g., threads, processes, computing devices). In some embodiments, remote component(s) 2310 can be a distributed computer system, connected to a local automatic scaling component and/or programs that use the resources of a distributed computer system, via communication framework 2340. Communication framework 2340 can comprise wired network devices, wireless network devices, mobile devices, wearable devices, radio access network devices, gateway devices, femtocell devices, servers, etc.

The system 2300 also comprises one or more local component(s) 2320. The local component(s) 2320 can be hardware and/or software (e.g., threads, processes, computing devices). In some embodiments, local component(s) 2320 can comprise an automatic scaling component and/or programs that communicate/use the remote resources 2310 and 2320, etc., connected to a remotely located distributed computing system via communication framework 2340.

One possible communication between a remote component(s) 2310 and a local component(s) 2320 can be in the form of a data packet adapted to be transmitted between two or more computer processes. Another possible communication between a remote component(s) 2310 and a local component(s) 2320 can be in the form of circuit-switched data adapted to be transmitted between two or more computer processes in radio time slots. The system 2300 comprises a communication framework 2340 that can be employed to facilitate communications between the remote component(s) 2310 and the local component(s) 2320, and can comprise an air interface, e.g., Uu interface of a UMTS network, via a long-term evolution (LTE) network, etc. Remote component(s) 2310 can be operably connected to one or more remote data store(s) 2350, such as a hard drive, solid state drive, SIM card, device memory, etc., that can be employed to store information on the remote component(s) 2310 side of communication framework 2340. Similarly, local component(s) 2320 can be operably connected to one or more local data store(s) 2330, that can be employed to store information on the local component(s) 2320 side of communication framework 2340.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a computing system comprising at least one processor, queries to be processed using a transformer model in association with processing tokenized representations of respective input data samples of the queries, the tokenized representations comprising respective initial token numbers of execution tokens;
determining, based on one or more characteristics of the queries, by the system, token adaptation settings applicable to processing the queries using the transformer model, wherein at least some of the token adaptation settings comprise adjusting, using the transformer model, at least some corresponding initial token numbers via at least one of a token prompting process or a token merging process; and
applying, by the system, the queries as input to the transformer model, which employs the token adaptation settings, to generate inference results corresponding to the queries.

2. The method of claim 1, wherein the adjusting of the at least some corresponding initial token numbers using the transformer model via the token prompting process results in increasing an accuracy level of the inference results, and wherein the adjusting of the at least some corresponding initial token numbers via the token merging process results in decreasing a latency level of the transformer model in association with the processing of the queries.

3. The method of claim 1, wherein the one or more characteristics are selected from the group consisting of: a first characteristic applicable to input data sample content, a second characteristic applicable to a query task, a third characteristic applicable to a utility value and a fourth characteristic applicable to a latency requirement.

4. The method of claim 3, wherein the token adaptation settings vary amongst the queries based on different characteristics of the queries.

5. The method of claim 1, wherein the determining of the token adaptation settings comprises determining changes to at least some of the initial token numbers for usage by the transformer model in association with the processing of the queries using the transformer model based on the one or more characteristics.

6. The method of claim 1, wherein the one or more characteristics comprise respective task types of the queries, and wherein the determining of the token adaptation settings comprises determining the token adaptation settings based on task profile data for the respective task types indicating how different adjustments to the respective initial token numbers impact an accuracy level of the inference results and a latency level of the transformer model in association with the processing of the queries.

7. The method of claim 6, wherein the different adjustments comprise adding predefined prompt tokens to the execution tokens tailored to the respective task types.

8. The method of claim 1, wherein the determining of the token adaptation settings comprises determining the token adaptation settings based on a current query load of the queries.

9. The method of claim 1, wherein usage of the transformer model comprises employing an encoder configured to perform the at least one of the token prompting process or the token merging process.

10. A method, comprising:
receiving, by a computing system comprising at least one processor, queries for processing by a transformer model in association with processing tokenized representations of respective input data samples of the queries, the tokenized representations comprising respective initial token numbers of execution tokens;
assigning, by the computing system, the queries into different batches respectively comprising different subsets of the queries;
for each batch of the different batches:
determining, by the system, a token adaptation number for respective execution tokens of respective queries included in the batch based on one or more characteristics of the queries included the batch;
directing, by the system, the transformer model to apply token adaptation number to adjust or maintain respective initial token numbers of the respective execution tokens in association with applying the batch as input to the transformer model; and
applying, by the system, the batch as input to the transformer model, configured to apply the token adaption number to adjust or maintain the respective initial token numbers of the respective execution tokens in association with applying the batch as input to the transformer model, to generate inference results for the queries included in the batch.

11. The method of claim 10, wherein:
based on the token adaptation number being greater than a threshold number, the transformer model, configured according to the token adaptation number, adds one or more prompt tokens to the respective execution tokens,
based on the token adaptation number being less than the threshold number, the transformer model, configured according to the token adaptation number, reduces the respective initial token numbers using a token merging process, and
based on the token adaptation number being equal to the threshold number, the transformer model, configured according to the token adaptation number, maintains the respective initial token numbers.

12. The method of claim 11, wherein, based on adding the one or more prompt tokens, an accuracy level of the inference results is increased for the batch, and wherein, based on reducing the initial token number, a latency level of the transformer model is decreased in association with the processing of the batch.

13. The method of claim 10, wherein the assigning comprises assigning the queries into the different batches by grouping similar queries having a similar characteristic in a same batch in accordance with a defined similarity criterion or a defined similarity metric, and wherein the similar characteristic is selected from a group comprising: a first characteristic relating to an arrival time, a second characteristic relating to a query task, a third characteristic relating to a utility value, and a fourth characteristic relating to a latency requirement.

14. The method of claim 13, further comprising:
determining, by the system, an execution order for the different batches based on arrival times of different queries included in the different batches;
storing, by the system, the different batches in a batch queue; and
applying, by the system, the transformer model to the different sequentially batches in accordance with the execution order.

15. The method of claim 10, wherein the determining of the token adaptation number comprises determining the token adaptation number for respective execution tokens of respective queries included in the batch based on a query load of the batch queue.

16. The method of claim 10, wherein the one or more characteristics are selected from the group consisting of: a first characteristic applicable to input data sample content, a second characteristic applicable to a query task, a third characteristic applicable to a utility value and a fourth characteristic applicable to a latency requirement.

17. The method of claim 10, wherein the one or more characteristics comprise a task type of the respective queries included in the batch, and wherein the determining of the token adaptation number comprises determining the token adaptation number based on task profile data for the task type indicating how different adjustments to one or more of the respective initial token numbers impact an accuracy level of the inference results and a latency level of the transformer model in association with the processing of the batch.

18. A computing system, comprising at least one processor configured to:
receive queries for processing by a transformer model in association with processing tokenized representations of respective input data samples of the queries, the tokenized representations comprising respective initial token numbers of execution tokens;
determine token adaptation settings for the processing of the queries using the transformer model based on one or more characteristics of the queries, wherein at least some of the token adaptation settings comprise adjusting at least some the respective initial token numbers using the transformer model via at least one of a token prompting process or a token merging process; and
after directing the transformer model to employ the token adaptation settings, apply the queries as input to the transformer model to generate inference results for the queries.

19. The computing system of claim 18, wherein the adjusting of the at least some corresponding initial token numbers using the transformer model via the token prompting process results in increasing an accuracy level of the inference results, and wherein the adjusting of the at least some corresponding initial token numbers via the token merging process results in decreasing a latency level of the transformer model in association with the processing of the queries.

20. The computing system of claim 18, wherein the one or more characteristics are selected from the group consisting of: a first characteristic applicable to input data sample content, a second characteristic applicable to a query task, a third characteristic applicable to a utility value and a fourth characteristic applicable to a latency requirement.
